(19) United States
(12) Patent Application Publication
(10) Pub. No.: US 2024/0423107 A1
(43) Pub. Date: Dec. 26, 2024

(54) WORKING MACHINE

(71) Applicant: MAKITA CORPORATION, Anjo-shi (JP)

(72) Inventors: Hideaki SUGIURA, Anjo-shi (JP); Ryo SUNAZUKA, Anjo-shi (JP)

(73) Assignee: MAKITA CORPORATION, Anjo-shi (JP)

(21) Appl. No.: 18/745,522

(22) Filed: Jun. 17, 2024

(30) Foreign Application Priority Data
Jun. 20, 2023 (JP) 2023-100973
Feb. 27, 2024 (JP) 2024-027377

(51) Int. Cl. A01B 1/22; A01B 1/06; A01B 1/08; A01B 1/12; B25F 5/02

(52) U.S. Cl. CPC A01B 1/225; A01B 1/065; B25F 5/02; A01B 1/08; A01B 1/12

(57) ABSTRACT

A working machine may include: a prime mover; an output shaft configured to move by movement of the prime mover; a first adjusting member detachably attached to the output shaft; and a working member detachably attached to the first adjusting member. The first adjusting member may include: an attaching part attached to the output shaft; and an adjusting part attached to the working member and configured to adjust an attaching posture of the working member relative to the first adjusting member.

### REFERENCE TO RELATED APPLICATIONS

This application claims priority to Japanese Patent Application No. 2023-100973, filed on Jun. 20, 2023 and Japanese Patent Application No. 2024-027377, filed on Feb. 27, 2024, the entire contents of which are hereby incorporated by reference into the present application.

### TECHNICAL FIELD

The disclosure herein relates to a working machine.

### BACKGROUND ART

US Patent Application Publication No. 2013/0098644 describes a working machine. The working machine includes a prime mover, an output shaft configured to move by movement of the prime mover, an intermediate member detachably attached to the output shaft, and a working member fixed to the intermediate member. The output shaft includes an adjusting part configured to adjust an attaching posture of the intermediate member relative to the output shaft.

U.S. Pat. No. 4,351,396 describes a working machine. The working machine includes a shaft, a working member including a first portion disposed at one end of the shaft in a longitudinal direction of the shaft and a second portion disposed at another end of the shaft in the longitudinal direction, a first swing member attached to the one end of the shaft in a state being interposed between the first portion of the working member and a first bush on the shaft and configured to swing by movement of a prime mover, a second swing member attached to the other end of the shaft in a state interposed between the second portion of the working member and a second bush on the shaft and configured to move by the movement of the prime mover, a first fastener inserted into the one end of the shaft and attaching the first portion of the working member to the one end of the shaft, and a second fastener inserted into the other end of the shaft and attaching the second portion of the working member to the other end of the shaft. When the first swing member and the second swing member swing, the working member swings.

### SUMMARY

In the above-mentioned working machine of US Patent Application Publication No. 2013/0098644, since the adjusting part is disposed on the output shaft, processing of the adjusting part on the output shaft is difficult.

In the working machine of U.S. Pat. No. 4,351,396, load is applied on the working member if the working member is pressed against the ground while the working member is swinging. Due to this, the first portion of the working member swings relative to the first swing member and the second portion of the working member swings relative to the second swing member. Thus, the swinging of the first portion of the working member causes the first fastener attached to the shaft to be loosened. Likewise, the swinging of the second portion of the working member causes the second fastener attached to the shaft to be loosened.

The present disclosure provides at least one of: an art configured to adjust an attaching posture of a working member by using a component easy to process; and an art configured to suppress a fastener from being loosened when load is applied to the working member.

A working machine disclosed herein may comprise: a prime mover; an output shaft configured to move by movement of the prime mover; a first adjusting member detachably attached to the output shaft; and a working member detachably attached to the first adjusting member. The first adjusting member may comprise: an attaching part attached to the output shaft; and an adjusting part attached to the working member and configured to adjust an attaching posture of the working member relative to the first adjusting member.

According to the above configuration, the output shaft and the first adjusting member can be processed separately. Thus, the attaching posture of the working member relative to the first adjusting member can be adjusted by using the output shaft and the first adjusting member that are easy to process.

A working machine disclosed herein may comprise: a prime mover; an output shaft having a hollow shape and configured to move by movement of the prime mover; a working member comprising a first portion disposed at one end of the output shaft in a longitudinal direction of the output shaft and a second portion disposed at another end of the output shaft in the longitudinal direction, the working member being configured to move by movement of the output shaft; and a fastener penetrating the output shaft in the longitudinal direction and configured to attach the working member to the output shaft by interposing the first portion and the second portion between the fastener. The fastener may be not directly attached to the output shaft.

In the configuration where the working member is attached to the output shaft by the first and second portions being interposed between the fastener and the fastener is directly attached to the output shaft, the fastener swings relative to the first and second portions when load is applied to the working member. Due to this, the fastener attached to the output shaft is loosened. According to the above configuration, the working member is attached to the output shaft by the first and second portions being interposed between the fastener, whereas on the other hand, the fastener is not directly attached to the output shaft. Thus, even when load is applied to the working member, the working member operates unitedly with the fastener. Due to this, the fastener can be suppressed from being loosened.

### BRIEF DESCRIPTION OF DRAWINGS

FIG. 1 illustrates a perspective view of a working machine 2 according to a first embodiment.

FIG. 2 illustrates an exploded, perspective view of the working machine 2 according to the first embodiment in vicinity of a rear-end unit 8.

FIG. 3 illustrates a perspective view of the working machine 2 according to the first embodiment in vicinity of a front-end unit 10.

FIG. 4 illustrates a cross-sectional view of the front-end unit 10 in the working machine 2 according to the first embodiment.

FIG. 5 illustrates a side view of the working machine 2 according to the first embodiment with a front-end right housing 42 removed therefrom.

FIG. 6 illustrates an exploded, perspective view of a transmission mechanism 90, a blade 86, and a counterweight 88 according to the first embodiment.

FIG. 7 illustrates an exploded, perspective view of the transmission mechanism 90, the blade 86, and the counterweight 88 according to the first embodiment.

FIG. 8 illustrates a side view of the working machine 2 according to the first embodiment with a left cover 46 removed therefrom.

FIG. 9 illustrates a cross-sectional view of the front-end unit 10 in the working machine 2 according to the first embodiment.

FIG. 10 illustrates a cross-sectional view of the front-end unit 10 in the working machine 2 according to the first embodiment.

FIG. 11 illustrates a front view of the transmission mechanism 90, the blade 86, and the counterweight 88 according to the first embodiment.

FIG. 12 illustrates a side view of the working machine 2 according to the first embodiment with the left cover 46 removed therefrom.

FIG. 13 illustrates a side view of the working machine 2 according to the first embodiment with the front-end right housing 42 removed therefrom.

FIG. 14 illustrates an exploded, perspective view of a first transmission unit 78, a first output shaft 82, the blade 86, and adjusting members 160 according to the first embodiment.

FIG. 15 illustrates an exploded, perspective view of the first transmission unit 78, the first output shaft 82, the blade 86, and the adjusting members 160 according to the first embodiment.

FIG. 16 illustrates an exploded, perspective view of the first output shaft 82 and a first adjusting member 170 according to the first embodiment.

FIG. 17 illustrates a cross-sectional view of the first output shaft 82, the blade 86, and the first adjusting member 170 according to the first embodiment.

FIG. 18 illustrates a cross-sectional view of the first output shaft 82 and the first adjusting member 170 according to the first embodiment.

FIG. 19 illustrates an exploded, perspective view of the first output shaft 82 and a second adjusting member 172 according to the first embodiment.

FIG. 20 illustrates a cross-sectional view of the first output shaft 82, the blade 86, and the second adjusting member 172 according to the first embodiment.

FIG. 21 illustrates a perspective view of a right attaching part 120 of the blade 86 according to the first embodiment.

FIG. 22 illustrates a perspective view of a left attaching part 124 of the blade 86 according to the first embodiment.

FIG. 23 illustrates a perspective view of the working machine 2 according to the first embodiment in vicinity of the front-end unit 10 in a state where a blade cover 300 is attached to a blade part 116.

FIG. 24 illustrates a lateral cross-sectional view of the blade 86 and the blade cover 300 according to the first embodiment in a state where the blade cover 300 is attached to the blade 86.

FIG. 25 illustrates a front cross-sectional view of the blade 86 and the blade cover 300 according to the first embodiment in the state where the blade cover 300 is attached to the blade 86.

FIG. 26 illustrates a lateral cross-sectional view of the blade 86 and the blade cover 300 according to the first embodiment before the blade cover 300 is attached to the blade 86.

FIG. 27 illustrates a front view of the working machine 2 according to the first embodiment in vicinity of the front-end unit 10 during attachment of the blade cover 300 to the blade 86.

FIG. 28 illustrates a cross-sectional view of the working machine 2 according to the first embodiment before the blade cover 300 is attached to a pole 4.

FIG. 29 illustrates a cross-sectional view of the working machine 2 according to the first embodiment in a state where the blade cover 300 is attached to the pole 4.

FIG. 30 illustrates a cross-sectional view of the front-end unit 10 in a working machine 2 according to a second embodiment.

FIG. 31 illustrates an enlarged, cross-sectional view of a head part 422 and its vicinity in the working machine 2 according to the second embodiment.

FIG. 32 illustrates an enlarged, cross-sectional view of a nut 416 and its vicinity in the working machine 2 according to the second embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved working machines, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A working machine disclosed herein may comprise: a prime mover; an output shaft configured to move by movement of the prime mover; a first adjusting member detachably attached to the output shaft; and a working member detachably attached to the first adjusting member. The first adjusting member may comprise: an attaching part attached to the output shaft; and an adjusting part attached to the working member and configured to adjust an attaching posture of the working member relative to the first adjusting member.

In one or more embodiments, the output shaft may comprise a first shaft positioning part. The attaching part may comprise a positioning part disposed at a specific position relative to the first shaft positioning part when the output shaft is attached to the attaching part.

According to the above configuration, by way of a simple method of arranging the positioning part at a specific position relative to the first shaft positioning part, the attaching part can be positioned at the specific position relative to the output shaft.

In one or more embodiments, the output shaft may be inserted into the attaching part. The first shaft positioning part may be disposed on an outer surface of the output shaft. The positioning part may be disposed to face the first shaft positioning part when the output shaft is inserted into the attaching part.

According to the above configuration, the attaching part can be easily disposed at the specific position relative to the output shaft by inserting the output shaft into the attaching part with the first shaft positioning part facing the positioning part.

In one or more embodiments, the first shaft positioning part may comprise a first shaft planar part having a planar shape. The positioning part may comprise a first planar part having a planar shape and configured to face and contact the first shaft planar part when the output shaft is inserted into the attaching part.

According to the above configuration, when force about the output shaft is applied on the first adjusting member, the first planar part is pressed against the first shaft planar part. Due to this, the first adjusting member can be suppressed from rotating about the output shaft.

In one or more embodiments, the first shaft positioning part may further comprise a second shaft planar part having a planar shape. The positioning part may comprise a second planar part having a planar shape and configured to face and contact the second shaft planar part when the output shaft is inserted into the attaching part.

According to the above configuration, when the force about the output shaft is applied on the first adjusting member, the first planar part is pressed against the first shaft planar part, and the second planar part is pressed against the second shaft planar part. Due to this, the first adjusting member can be further suppressed from rotating about the output shaft.

In one or more embodiments, the working member may be configured to swing about a swing axis by movement of the output shaft.

According to the above configuration, in the configuration where the working member swings, the attaching posture of the working member relative to the first adjusting member needs to be adjusted in accordance with a posture in which the user works. In the configuration where the working member swings as mentioned above, the attaching posture of the working member relative to the first adjusting member can be adjusted by using the output shaft and the first adjusting member that are easy to process.

In one or more embodiments, the first adjusting member may include an outer peripheral surface having a circular shape with a center on the swing axis. The adjusting part may be disposed at a portion of the outer peripheral surface of the first adjusting member along a circumferential direction of the first adjusting member.

In a configuration where the adjusting part is disposed on an entirety of the outer peripheral surface of the first adjusting member along the circumferential direction of the first adjusting member, when the working member is being attached at a certain position relative to the first adjusting member, the working member may contact a component of the working machine, for example, a housing, during work. According to the above configuration, because the adjusting part is disposed at a portion of the outer peripheral surface of the first adjusting member along the circumferential direction of the first adjusting member, the working member can be suppressed from contacting a component of the working machine, e.g., a housing, during work.

In one or more embodiments, in a first direction along which the swing axis extends, a width of the adjusting part may be equal to or more than 30% and equal to or less than 70% of a width of the first adjusting member.

According to the above configuration, both of a strength of the adjusting part and a strength of an entirety of the first adjusting member can be suppressed from being excessively decreased.

In one or more embodiments, one of the adjusting part and the working member may comprise a plurality of receiving grooves aligned about the swing axis. Another of the adjusting part and the working member may comprise a plurality of protrusions aligned about the swing axis. Each of the plurality of protrusions may be configured to be received in a corresponding one the plurality of receiving grooves. A number of the plurality of protrusions may be less than a number of the plurality of receiving grooves.

According to the above configuration, the attaching posture of the working member relative to the first adjusting member can be easily adjusted by changing a position of the plurality of protrusions relative to the plurality of receiving grooves.

In one or more embodiments, the fastener may comprise: a bolt comprising a head part configured to contact the first portion and a shaft part configured to penetrate the output shaft in the longitudinal direction; and a nut configured to contact the second portion and be screwed with the shaft part.

According to the above configuration, with a simple configuration of the fastener, the fastener can be suppressed from being loosened.

In one or more embodiments, the nut may be permanently attached to the second portion.

According to the above configuration, even if load is applied to the working member, the working member can easily operate unitedly with the fastener. Due to this, the fastener can be further suppressed from being loosened.

A working machine disclosed herein may comprise: a prime mover; an output shaft having a hollow shape and configured to move by movement of the prime mover; a working member comprising a first portion disposed at one end of the output shaft in a longitudinal direction of the output shaft and a second portion disposed at another end of the output shaft in the longitudinal direction, the working member being configured to move by movement of the output shaft; and a fastener penetrating the output shaft in the longitudinal direction and configured to attach the working member to the output shaft by interposing the first portion and the second portion between the fastener. The fastener may not be directly attached to the output shaft.

In one or more embodiments, the fastener may comprise: a bolt comprising a head part configured to contact the first portion and a shaft part configured to penetrate the output shaft in the longitudinal direction; and a nut configured to contact the second portion and be screwed with the shaft part.

According to the above configuration, with a simple configuration of the fastener, the fastener can be suppressed from being loosened.

In one or more embodiments, the nut may be permanently attached to the second portion.

According to the above configuration, even if load is applied to the working member, the working member can easily operate unitedly with the fastener. Due to this, the fastener can be further suppressed from being loosened.

In one or more embodiments, the working member may be configured to swing about a swing axis by the movement of the output shaft.

For example, in a configuration where the working member rotates, when the working member comes into contact with the ground, for example, load in a rotating direction of the working member is applied on the working member. Contrary to this, in the configuration where the working member swings, when the working member comes into contact with the ground, for example, load in a first swinging direction of the working member and load in a second swinging direction of the working member opposite from the first swinging direction are alternately applied on the working member. Due to this, in the configuration where the working member swings, the fastener can be more easily loosened than in the configuration where the working member rotates. According to the above configuration, in a configuration where the fastener can be easily loosened, the fastener can be suppressed from being loosened.

In one or more embodiments, the working machine may further comprise a first intermediate member attached to the output shaft. The first portion may be attached to the output shaft via the first intermediate member.

In the above configuration, wobbling of the first intermediate member relative to the output shaft and wobbling of the first portion relative to the first intermediate member may take place. In a configuration where the fastener is directly attached to the output shaft, when load is applied on the working member, the fastener slides relative to the first portion due to the wobbling of the first intermediate member relative to the output shaft and the wobbling of the first portion relative to the first intermediate member. Due to this, the fastener can be easily loosened. Contrary to this, according to the above configuration, because the fastener is not directly attached to the output shaft, even when load is applied on the working member, the fastener can be suppressed from sliding relative to the first portion due to the wobbling of the first intermediate member relative to the output shaft and the wobbling of the first portion relative to the first intermediate member. Due to this, the fastener can be suppressed from being loosened.

In one or more embodiments, the first intermediate member may be configured to adjust an attaching posture of the working member relative to the first intermediate member.

In the configuration where the first intermediate member is configured to adjust the attaching posture of the working member relative to the first intermediate member, wobbling of the first portion relative to the first intermediate member can easily take place. According to the above configuration, in the configuration where the wobbling of the first portion relative to the first intermediate member can easily take place, the fastener can be suppressed from being loosened.

### First Embodiment

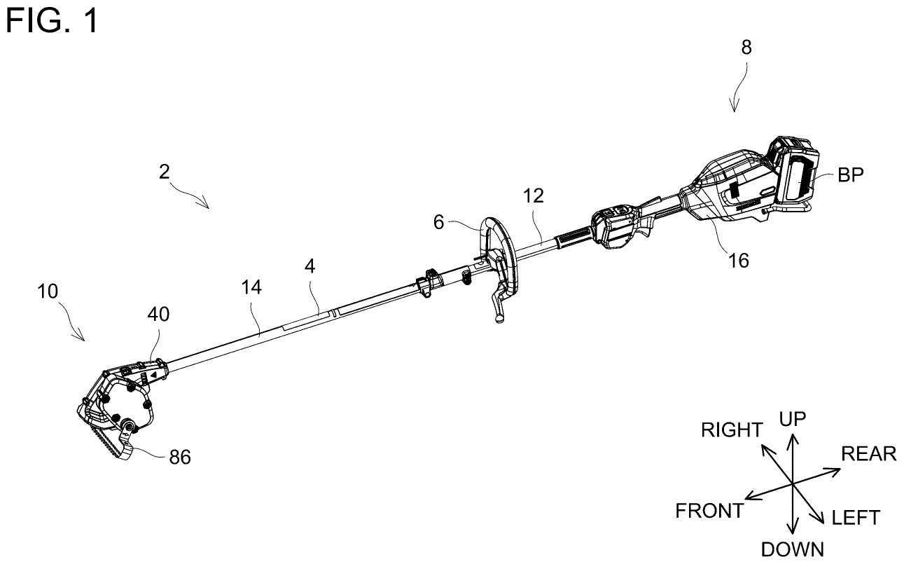

As shown in FIG. 1, a working machine 2 is a pole-type working machine. The working machine 2 is a weed remover configured to dig up ground soil and remove weed. The working machine 2 comprises a pole 4, a loop-shaped handle 6, a rear-end unit 8, and a front-end unit 10. A user grips the loop-shaped handle 6 with one hand, and grips the rear-end unit 8 with the other hand, and thus handles to move the working machine 2.

The pole 4 has an elongated rod shape. The pole 4 comprises a first pole 12 and a second pole 14. The first pole 12 is detachably attached to the second pole 14. The loop-shaped handle 6 is fixed to the first pole 12. Hereafter, a direction along which the pole 4 extends will be referred to as a front-rear direction, a direction perpendicular to the front-rear direction will be referred to as a left-right direction and a direction perpendicular to the front and left-right directions will be referred to as an up-down direction.

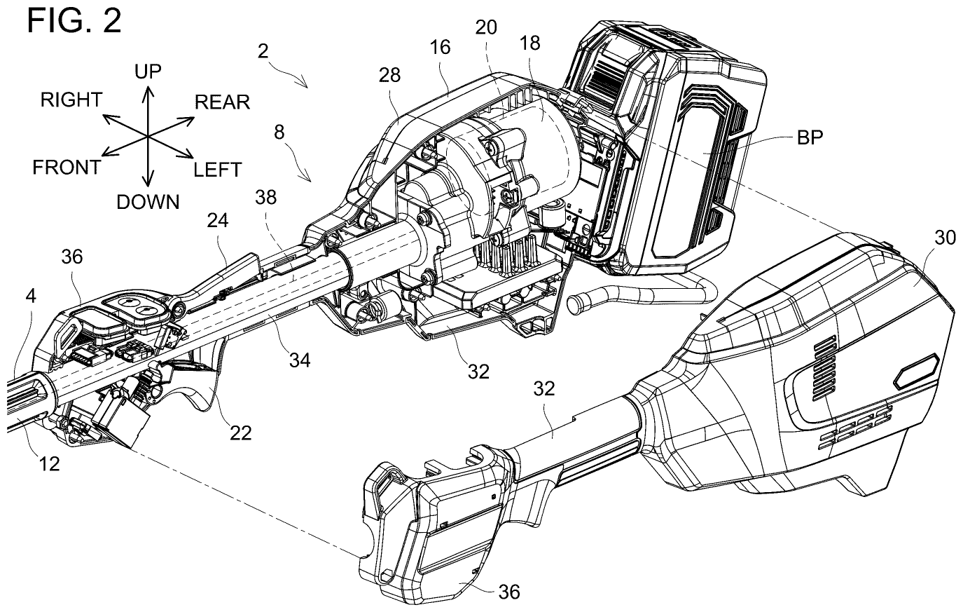

The rear-end unit 8 is fixed in vicinity of a rear end of the pole 4. As shown in FIG. 2, the rear-end unit 8 comprises a rear-end housing 16, a motor housing 18, a motor 20, a trigger 22, a shark fin 24, and a battery pack BP.

The rear-end housing 16 comprises a rear-end right housing 28 defining an outer shape of a right-half surface of the rear-end housing 16 and a rear-end left housing 30 defining an outer shape of a left-half surface of the rear-end housing 16. The rear-end housing 16 comprises a motor accommodating part 32, a grip part 34, and a switch accommodating part 36.

The battery pack BP is detachably attached to a rear surface of the motor accommodating part 32. The battery pack BP comprises a rechargeable secondary battery, such as a lithium-ion battery. The grip part 34 is configured to be gripped by the user during work with use of the working machine 2.

The motor housing 18 and the motor 20 are arranged within the motor accommodating part 32. The motor 20 is arranged within the motor housing 18. In FIG. 2, the motor 20 is shown in broken lines. The motor 20 is an example of a prime mover. The motor 20 is for example a brushless motor. When the motor 20 rotates, a transmission shaft 38 rotates about an axis extending along the front-rear direction. In FIG. 2, the transmission shaft 38 is shown in broken lines. The transmission shaft 38 is rotatably supported by the pole 4 within the pole 4.

The trigger 22 is attached below the switch accommodating part 36 such that the trigger 22 can be pressed in. The shark fin 24 is attached above the grip part 34 such that the shark fin 24 can be pressed in. When the shark fin 24 is pressed in, the trigger 22 becomes able to be pressed in. When the trigger 22 is pressed in by finger(s) of the user who is gripping the grip part 34 with the shark fin 24 pressed in by a palm of the user, the motor 20 starts to rotate.

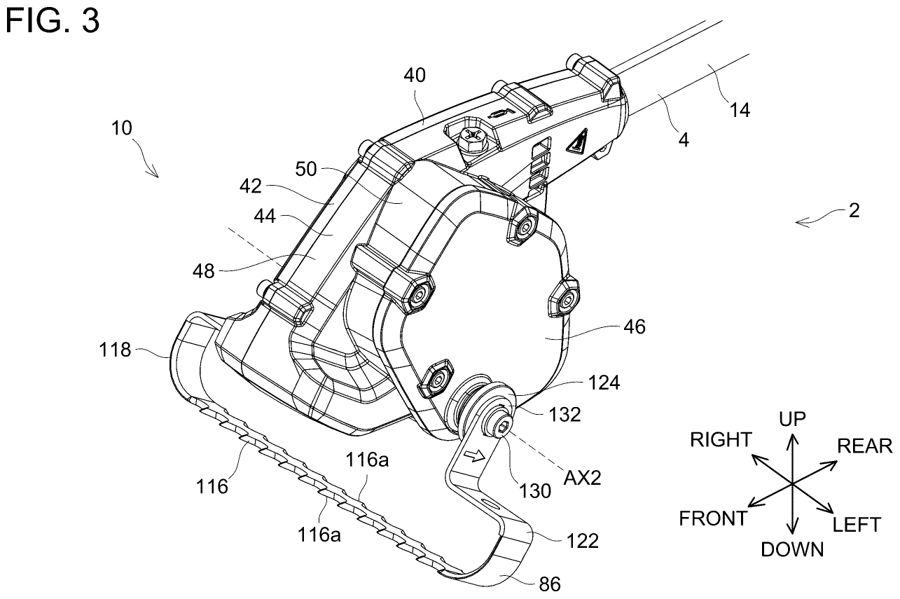

As shown in FIG. 3, the front-end unit 10 is fixed to a front end of the pole 4. The front-end unit 10 is an example of a blade unit. The front-end unit 10 comprises a front-end housing 40. The front-end housing 40 comprises a front-end right housing 42, a front-end left housing 44, and a left cover 46. The front-end right housing 42 defines an outer shape of a right half of the front-end housing 40. The front-end left housing 44 and the left cover 46 define an outer shape of a left half of the front-end housing 40.

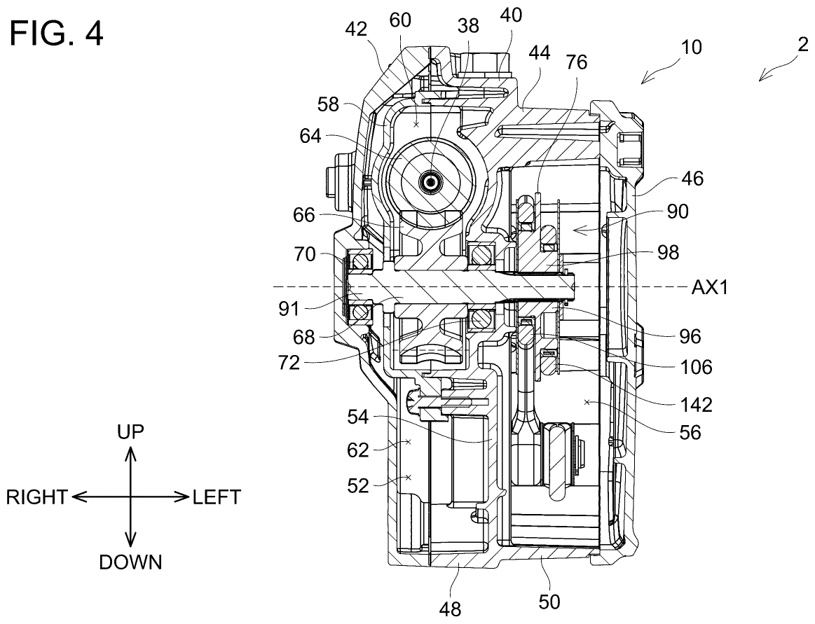

The front-end left housing 44 comprises a principal part 48 and an auxiliary part 50. The principal part 48 is fixed to the front-end right housing 42. The pole 4 is interposed between the principal part 48 and the front-end right housing 42. As shown in FIG. 4, the principal part 48 and the front-end right housing 42 define a right accommodating space 52. The principal part 48 comprises a partitioning wall 54, and the auxiliary part 50 protrudes leftward from the partitioning wall 54. The auxiliary part 50 is fixed to the left cover 46. The auxiliary part 50, the left cover 46, and the partitioning wall 54 define a rod accommodating space 56. The partitioning wall 54 divides an internal space of the front-end housing 40 into the right accommodating space 52 and the rod accommodating space 56.

The front-end housing 40 further comprises a worm cover 58. The worm cover 58 is fixed to the partitioning wall 54 from a right side of the partitioning wall 54. The worm cover 58 covers a portion of the partitioning wall 54. The worm cover 58 divides the right accommodating space 52 into a worm accommodating space 60 and a weight accommodating space 62. The worm accommodating space 60 is defined by the partitioning wall 54 and an inner surface of the worm cover 58. The weight accommodating space 62 is defined by the front-end right housing 42, the principal part 48, and an outer surface of the worm cover 58.

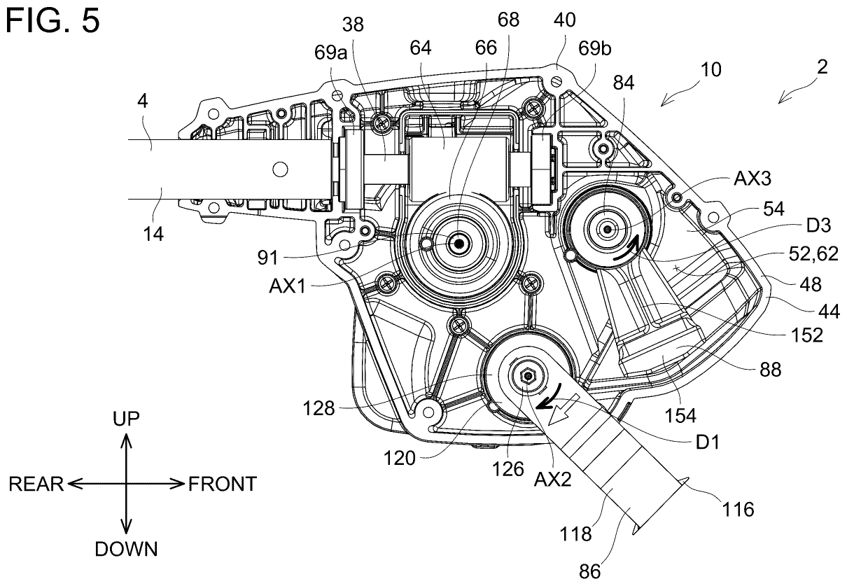

The front-end unit 10 further comprises a worm 64, the worm wheel 66, and a rotation shaft 68. The worm 64 and the worm wheel 66 are arranged in the worm accommodating space 60. As shown in FIG. 5, the worm 64 is fixed to an outer peripheral surface of a front end of the transmission shaft 38. The transmission shaft 38 is rotatably supported by the front-end housing 40 with bearings 69a, 69b, and the worm 64 is disposed between the bearings 69a, 69b. The worm wheel 66 interacts with the worm 64. When the worm 64 rotates about an axis extending along the front-rear direction with the transmission shaft 38, the worm wheel 66 rotates about a rotation axis AX1 extending in the left-right direction. A rotating speed of the worm wheel 66 is smaller than a rotating speed of the worm 64. Due to this, the worm 64 and the worm wheel 66 function as a reduction mechanism.

As shown in FIG. 4, the rotation shaft 68 is inserted into the worm wheel 66. The rotation shaft 68 is arranged inside the front-end housing 40. The rotation shaft 68 is rotatably supported by the front-end right housing 42 via a bearing 70. Also, the rotation shaft 68 is rotatably supported by the partitioning wall 54 via a bearing 72. The rotation shaft 68 rotates about the rotation axis AX1 together with the worm wheel 66. The rotation shaft 68 is inserted into an opening of the worm cover 58 and an opening of the partitioning wall 54. A proximity of a left end of the rotation shaft 68 is arranged in the rod accommodating space 56.

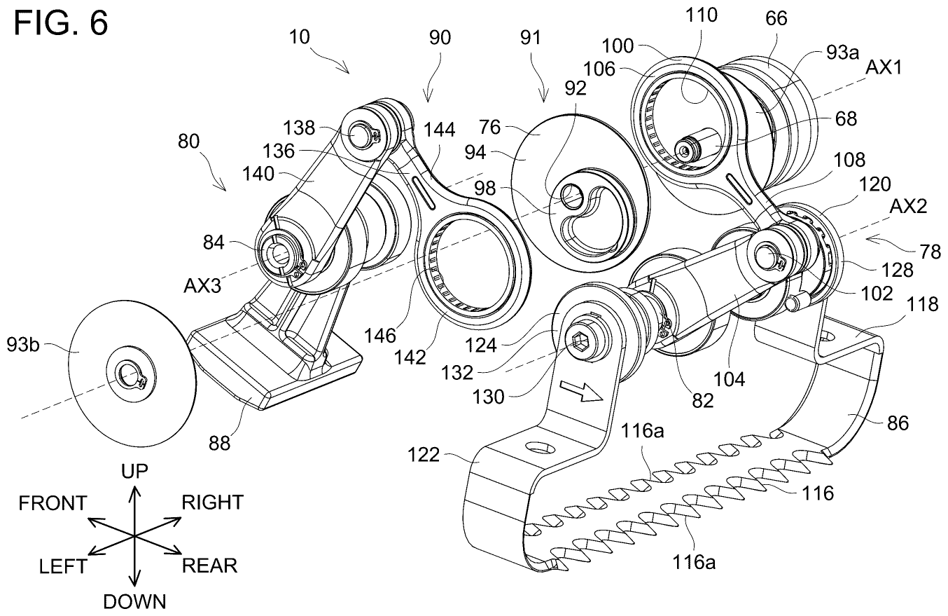

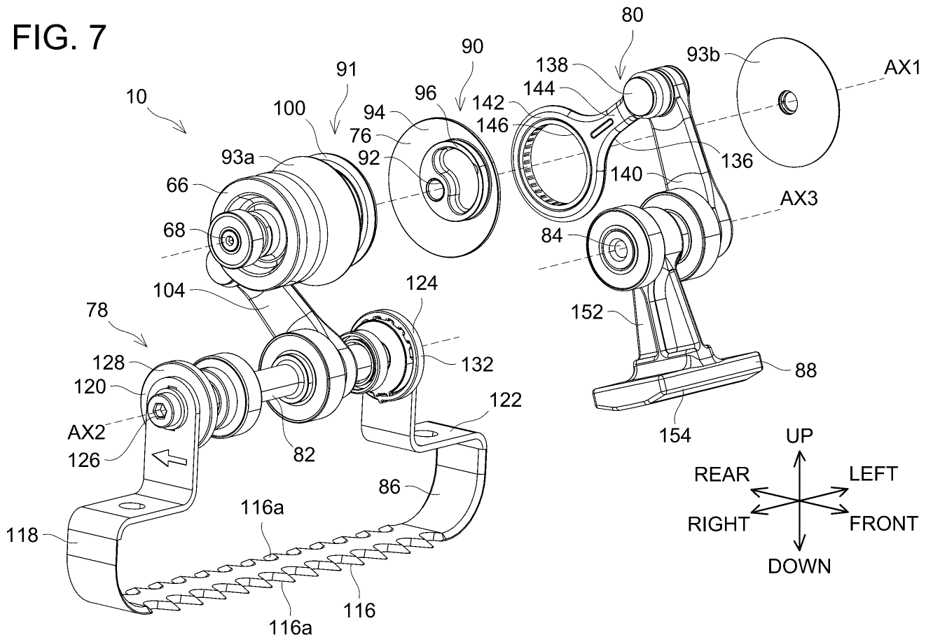

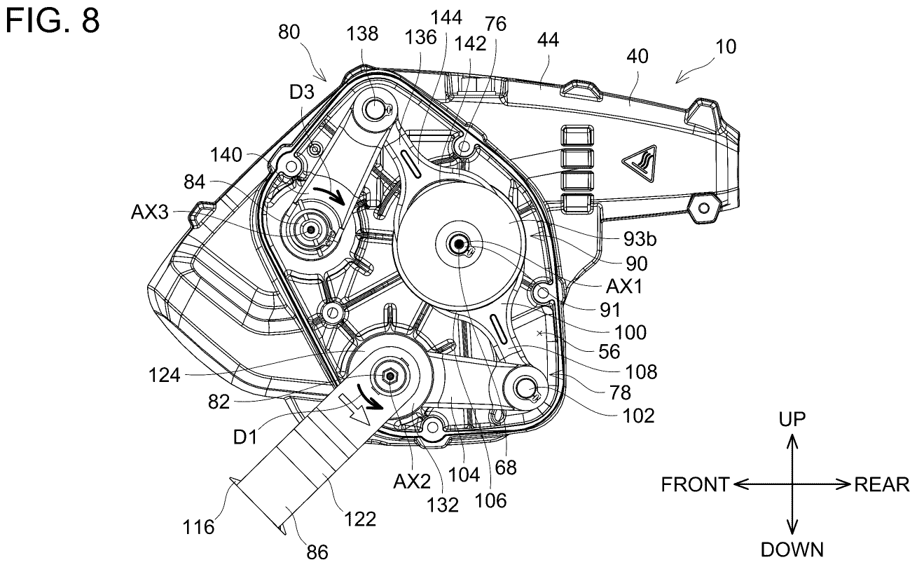

As shown in FIGS. 6 and 7, the front-end unit 10 comprises a disk 76, a first transmission unit 78, a second transmission unit 80, a first output shaft 82, a second output shaft 84, a blade 86, and a counterweight 88. As shown in FIG. 8, the disk 76 (see FIG. 4), the first transmission unit 78, and the second transmission unit 80 are arranged in the rod accommodating space 56. Hereafter, the rotation shaft 68, the disk 76, the first transmission unit 78, and the second transmission unit 80 may be collectively referred to as a transmission mechanism 90. Also, the rotation shaft 68 and the disk 76 may be collectively referred to as a rotation member 91.

As shown in FIGS. 6 and 7, the disk 76 has a shaft insertion hole 92 penetrating the disk 76 in the left-right direction. A left end of the rotation shaft 68 is inserted into the shaft insertion hole 92. The disk 76 is interposed between a pair of fixing plates 93a, 93b. Due to this, the disk 76 is fixed to the left end of the rotation shaft 68. The disk 76 rotates about the rotation axis AX1 together with the rotation shaft 68.

The disk 76 comprises a central plate part 94, a right disk part 96, and a left disk part 98. The central plate part 94 has a circular plate shape. The right disk part 96 is disposed on a right surface of the central plate part 94. The left disk part 98 is disposed on a left surface of the central plate part 94. When the disk 76 is viewed along the rotation axis AX1, the left disk part 98 partially overlaps the right disk part 96. An outer peripheral surface of the right disk part 96 and an outer peripheral surface of the left disk part 98 have a circular shape. A central axis of the outer peripheral surface of the right disk part 96 and a central axis of the outer peripheral surface of the left disk part 98 are offset from a central axis of the shaft insertion hole 92, i.e., offset from the rotation axis AX1. About the central axis of the shaft insertion hole 92, the central axis of the outer peripheral surface of the right disk part 96 is located at a position of 0 degrees, and the central axis of the outer peripheral surface of the left disk part 98 is located at a position of 180 degrees. When the central plate part 94 rotates, the right disk part 96 and the left disk part 98 rotate about the rotation axis AX1. A phase of rotational period of the right disk part 96 is shifted by 180 degrees from a phase of rotational period of the left disk part 98.

The first transmission unit 78 is attached to the right disk part 96. The first transmission unit 78 is attached to the blade 86 via the first output shaft 82. The first transmission unit 78 comprises a first rod 100, a first connection spindle 102, and a second rod 104.

The first rod 100 comprises a first attaching part 106 and a first arm part 108. The first attaching part 106 has a first disk insertion hole 110 penetrating the first attaching part 106 in the left-right direction. The right disk part 96 is inserted into the first disk insertion hole 110 via a bearing. The first attaching part 106 is disposed between the central plate part 94 and the fixing plate 93a. When the transmission mechanism 90 is viewed along the rotation axis AX1, the first attaching part 106 overlaps at least partially with the central plate part 94. The first arm part 108 protrudes from the first attaching part 106.

The first connection spindle 102 is inserted into a distal end of the first arm part 108. The first connection spindle 102 is inserted into one end of the second rod 104. The first connection spindle 102 extends in the left-right direction.

One end of the second rod 104 is attached to the first arm part 108 via the first connection spindle 102. The second rod 104 is attached to the first arm part 108 such that it is movable (revolvable) relative to the first rod 100. When the first transmission unit 78 is viewed along the rotation axis AX1, the first arm part 108 overlaps at least partially with the second rod 104.

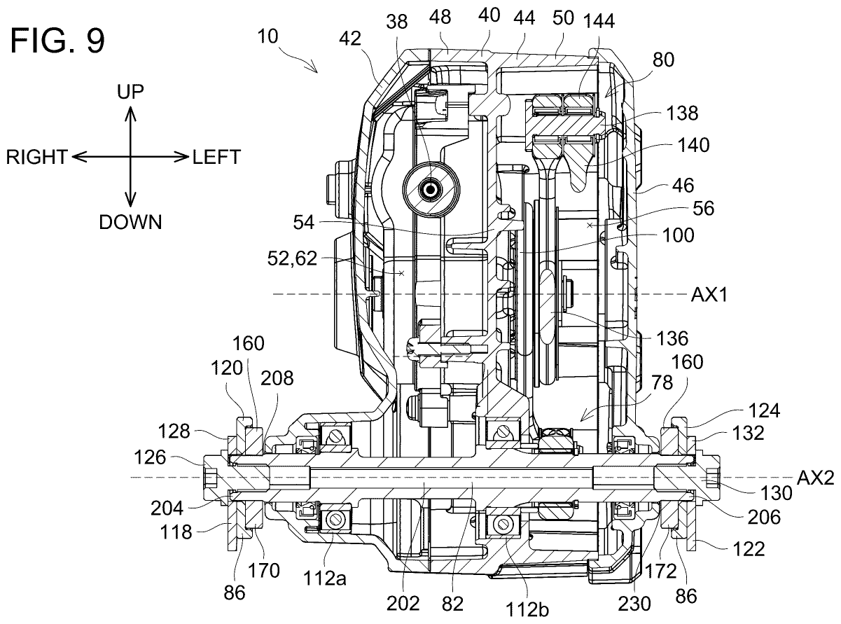

The first output shaft 82 is inserted into another end of the second rod 104. The first output shaft 82 is fixed to the other end of the second rod 104. The first output shaft 82 connects the other end of the second rod 104 and the blade 86. The first output shaft 82 extends in the left-right direction. A central axis AX2 of the first output shaft 82 extends in the left-right direction. The central axis AX2 is located on a front side relative to the rotation axis AX1. As shown in FIG. 9, the central axis AX2 is substantially parallel to the rotation axis AX1. The first output shaft 82 is revolvably supported by the front-end housing 40 via bearings 112a, 112b. Both ends of the first output shaft 82 are arranged outside the front-end housing 40.

The blade 86 is attached to the first output shaft 82. The blade 86 moves along with the first output shaft 82. The blade 86 is an example of a working member. The blade 86 is constituted of a metal material, for example. The blade 86 is arranged outside the front-end housing 40. In a modification, a portion of the blade 86 may be arranged outside the front-end housing 40. The blade 86 is supported by the front-end housing 40 via the first output shaft 82. As shown in FIGS. 6 and 7, the blade 86 comprises a blade part 116, a right connection part 118, a right attaching part 120, a left connection part 122, and a left attaching part 124.

The blade part 116 has a substantially planar shape extending in the left-right direction and the front-rear direction. The blade part 116 has a longitudinal direction in the left-right direction. A plurality of teeth 116a is defined each on a front end and a rear end of the blade part 116. The plurality of teeth 116a is aligned in the left-right direction at each of the front end and the rear end of the blade part 116.

One end of the right connection part 118 is connected to a right end of the blade part 116. The right connection part 118 extends upward from the right end of the blade part 116, then bends to extend leftward, and then further bends to extend upward. The right attaching part 120 is connected to another end of the right connection part 118. As shown in FIG. 9, the right attaching part 120 and the other end of the right connection part 118 are attached to a right end of the first output shaft 82 by a bolt 126. Hereafter, the right attaching part 120 and the other end of the right connection part 118 may be referred to as a first portion 128. The first portion 128 is supported by the front-end housing 40 via the first output shaft 82. The first portion 128 is disposed on the central axis AX2.

As shown in FIGS. 6 and 7, one end of the left connection part 122 is connected to a left end of the blade part 116. The left connection part 122 bends upward from the left end of the blade part 116, then bends to extend rightward, and further bends to extend upward. The left attaching part 124 is connected to another end of the left connection part 122. As shown in FIG. 9, the left attaching part 124 and the other end of the left connection part 122 are attached to a left end of the first output shaft 82 by a bolt 130. Hereafter, the left attaching part 124 and the other end of the left connection part 122 may be referred to as a second portion 132. The second portion 132 is supported by the front-end housing 40 via the first output shaft 82. The second portion 132 is disposed on the central axis AX2.

As shown in FIGS. 6 and 7, the second transmission unit 80 is attached to the left disk part 98. The second transmission unit 80 is attached to the counterweight 88 via the second output shaft 84. The second transmission unit 80 comprises a third rod 136, a second connection spindle 138, and a fourth rod 140.

A shape of the third rod 136 is substantially the same as a shape of the first rod 100. The third rod 136 comprises a third attaching part 142 and a third arm part 144. The third attaching part 142 has a third disk insertion hole 146 penetrating the third attaching part 142 in the left-right direction. The left disk part 98 is inserted into the third disk insertion hole 146 via a bearing. The third attaching part 142 is disposed between the central plate part 94 and the fixing plate 93b. When the transmission mechanism 90 is viewed along the rotation axis AX1, the third attaching part 142 overlaps at least partially with both the central plate part 94 and the first attaching part 106. A length of the third arm part 144 is substantially equal to a length of the first arm part 108.

A shape of the second connection spindle 138 is substantially same as a shape of the first connection spindle 102. The second connection spindle 138 is inserted into a distal end of the third arm part 144. The second connection spindle 138 is inserted into one end of the fourth rod 140. The second connection spindle 138 extends in the left-right direction.

A shape of the fourth rod 140 is substantially the same as a shape of the second rod 104. Due to this, a length of the fourth rod 140 is substantially equal to a length of the second rod 104. The one end of the fourth rod 140 is attached to the third arm part 144 via the second connection spindle 138. The fourth rod 140 is attached to the third arm part 144 such that it is movable (revolvable) relative to the third rod 136. When the second transmission unit 80 is viewed along the left-right direction, the third arm part 144 overlaps at least partially with the fourth rod 140.

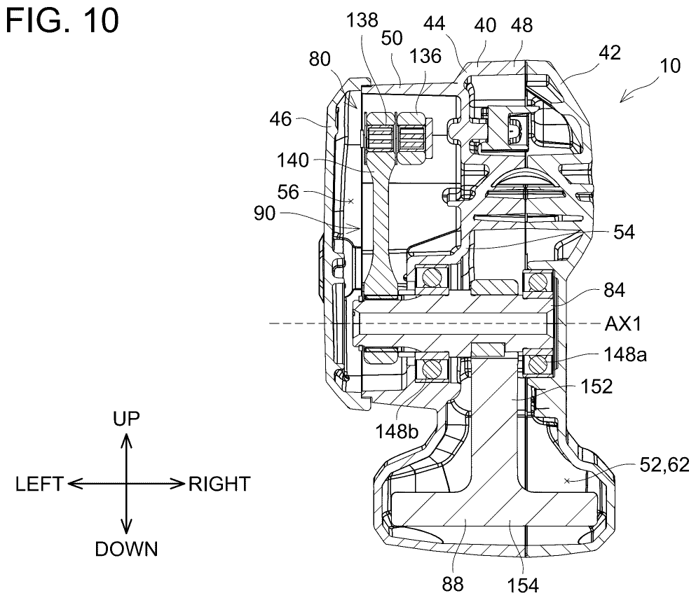

As shown in FIG. 10, the second output shaft 84 is inserted into another end of the fourth rod 140. The second output shaft 84 is fixed to the other end of the fourth rod 140. The second output shaft 84 connects the other end of the fourth rod 140 and the counterweight 88. The second output shaft 84 extends in the left-right direction. A central axis AX3 of the second output shaft 84 extends in the left-right direction. As shown in FIG. 5, the central axis AX3 is disposed on the front side relative to the rotation axis AX1 and the central axis AX2. The central axis AX3 is substantially parallel with both the rotation axis AX1 and the central axis AX2. A distance between the rotation axis AX1 and the central axis AX3 is substantially equal to a distance between the rotation axis AX1 and the central axis AX2. As shown in FIG. 10, the second output shaft 84 is revolvably supported by the front-end housing 40 via bearings 148a, 148b. The second output shaft 84 is disposed inside the front-end housing 40.

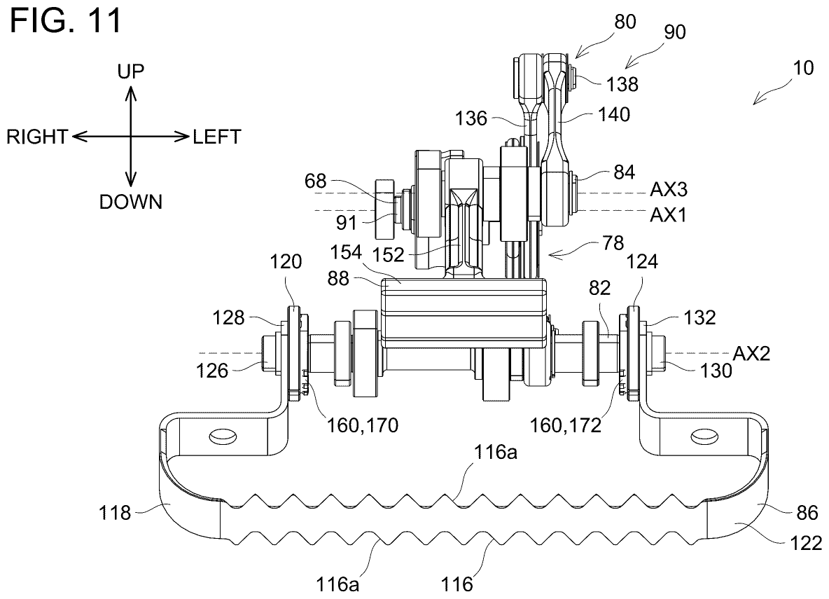

The counterweight 88 is fixed to the second output shaft 84. The counterweight 88 is for example, constituted of a metal material. The counterweight 88 has a substantially T shape. A weight of the counterweight 88 is greater than a weight of the blade 86. The counterweight 88 comprises a first extension part 152 extending from the second output shaft 84 and a second extension part 154 extending leftward and rightward from a distal end of the first extension part 152. As shown in FIG. 5, a distance between the central axis AX3 and the second extension part 154 is smaller than a distance between the central axis AX2 and the blade part 116 of the blade 86. As shown in FIG. 11, the counterweight 88 is located between the first portion 128 and the second portion 132 of the blade 86 in the left-right direction. In the left-right direction, a position of a center of the counterweight 88 in the left-right direction is substantially the same as a position of a center of the blade 86 in the left-right direction.

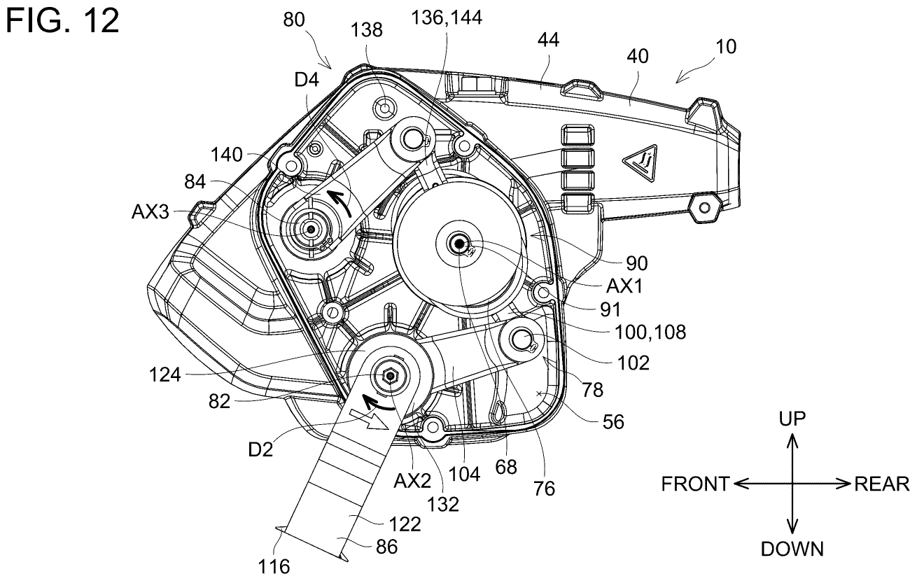

As shown in FIGS. 8 and 12, when the rotation shaft 68 rotates about the rotation axis AX1, the disk 76 rotates about the rotation axis AX1. Due to this, the right disk part 96 (see FIG. 7) and the left disk part 98 (see FIG. 7) rotate about the rotation axis AX1. The rotation of the right disk part 96 causes the first arm part 108 to move such that the first connection spindle 102 moves reciprocally between a first position (see FIG. 8) and a second position (see FIG. 12). Due to this, the second rod 104 swings about the central axis AX2, and the first output shaft 82 revolves about the central axis AX2. The first output shaft 82 moves in a first direction D1 (see FIG. 8) about the central axis AX2 when the first connection spindle 102 moves from the first position to the second position, whereas the first output shaft 82 moves in a second direction D2 (see FIG. 12) about the central axis AX2 when the first connection spindle 102 moves from the second position to the first position. The first direction D1 is opposite from the second direction D2. As a result, the blade 86 swings about the central axis AX2. The central axis AX2 corresponds to a swing axis of the blade 86. When the blade 86 contacts the ground while the blade 86 is swinging, the blade 86 digs up soil on the ground. Due to this, weeds growing on the ground are removed.

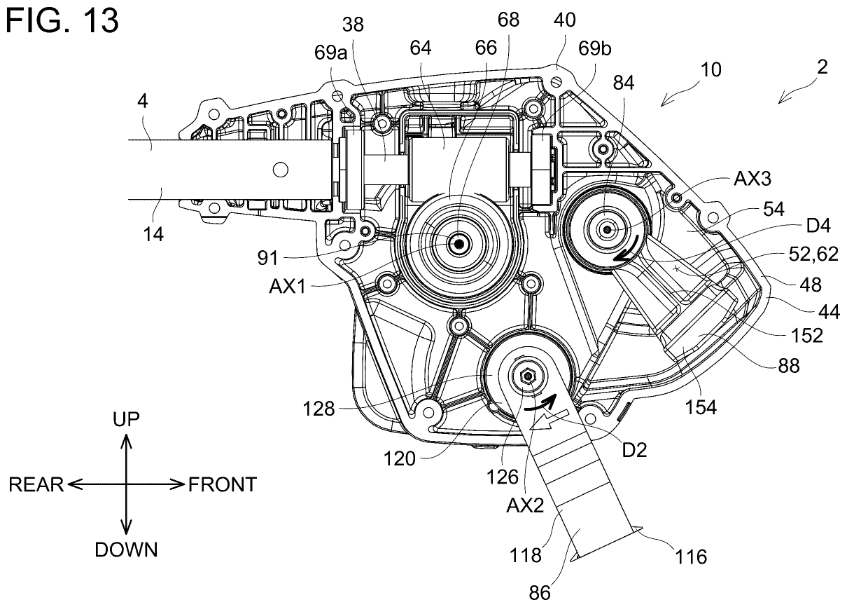

Likewise, the rotation of the left disk part 98 causes the third arm part 144 to move such that the second connection spindle 138 moves reciprocally between a third position (see FIG. 8) and a fourth position (see FIG. 12). Due to this, the fourth rod 140 swings about the central axis AX3, and the second output shaft 84 revolves about the central axis AX3. A revolving speed of the second output shaft 84 is substantially equal to a revolving speed of the first output shaft 82. The second output shaft 84 moves about the central axis AX3 in a third direction D3 (see FIG. 8) when the second connection spindle 138 moves from the third position to the fourth position, whereas the second output shaft 84 moves about the central axis AX3 in a fourth direction D4 (see FIG. 12) when the second connection spindle 138 moves from the fourth position to the third position. The third direction D3 is opposite from the first direction D1. The fourth direction D4 is opposite from each of the third direction D3 and the second direction D2. As shown in FIGS. 5 and 13, the counterweight 88 swings about the central axis AX3. The central axis AX3 corresponds to a swing axis of the counterweight 88. When the front-end unit 10 is seen from right, when the blade 86 swings clockwise (the first direction D1), the counterweight 88 swings counterclockwise (the third direction D3). Likewise, when the blade 86 swings counterclockwise (the second direction D2), the counterweight 88 swings clockwise (the fourth direction D4). That is, when the blade 86 swings to approach the counterweight 88, the counterweight 88 swings to approach the blade 86, whereas when the blade 86 swings to separate away from the counterweight 88, the counterweight 88 swings to separate away from the blade 86. As such, vibration of the front-end housing 40 due to the swinging of the blade 86 is cancelled by vibration of the front-end housing 40 due to the swinging of the counterweight 88.

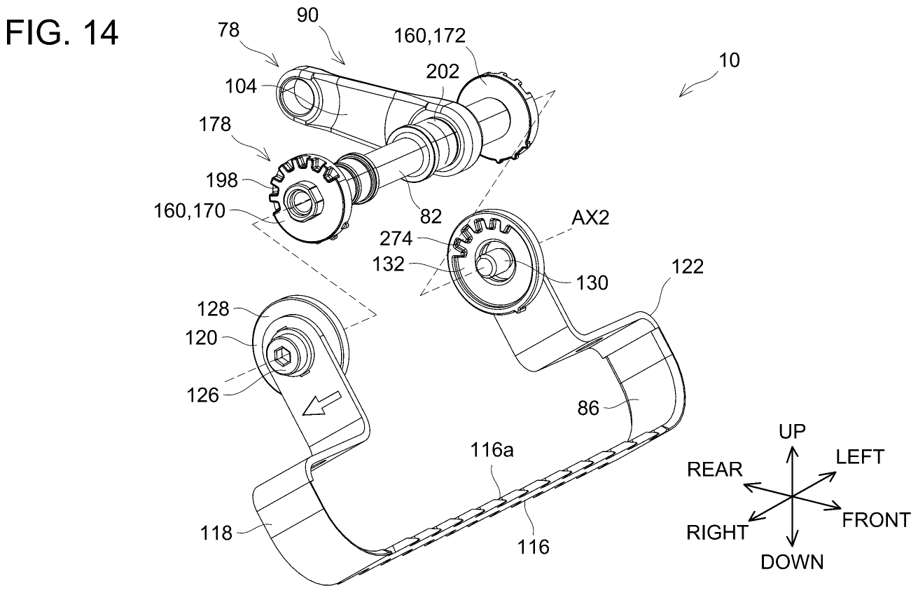

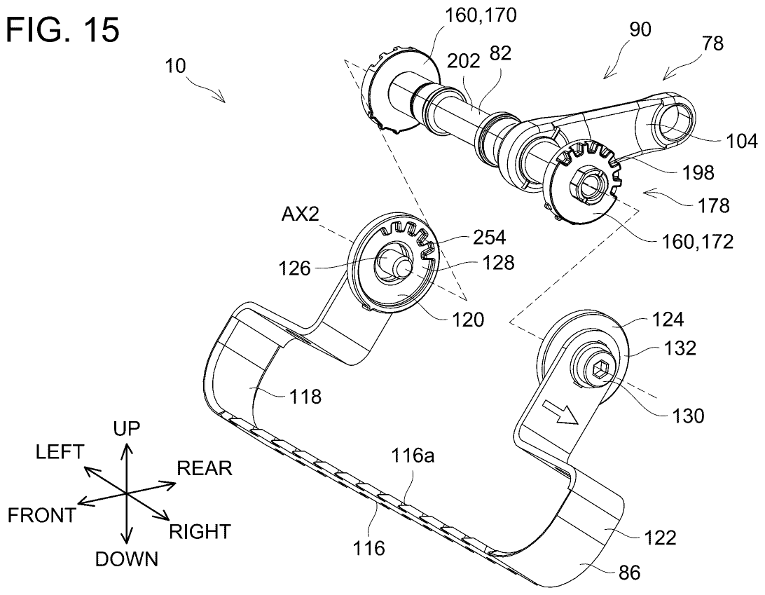

In the present embodiment, the blade 86 is attached to the first output shaft 82 such that an attaching posture of the blade 86 relative to the front-end housing 40 is adjustable. As shown in FIGS. 14 and 15, the front-end unit 10 comprises two adjusting members 160. The adjusting members 160 are detachably attached to the first output shaft 82. The adjusting members 160 are constituted of a metal material for example. In a modification, the adjusting members 160 may be constituted of a resin material. Hereafter, one of the adjusting members 160 may be referred to as a first adjusting member 170, and another of the adjusting members 160 may be referred to as a second adjusting member 172. Here, a shape of the first adjusting member 170 is substantially the same as a shape of the second adjusting member 172.

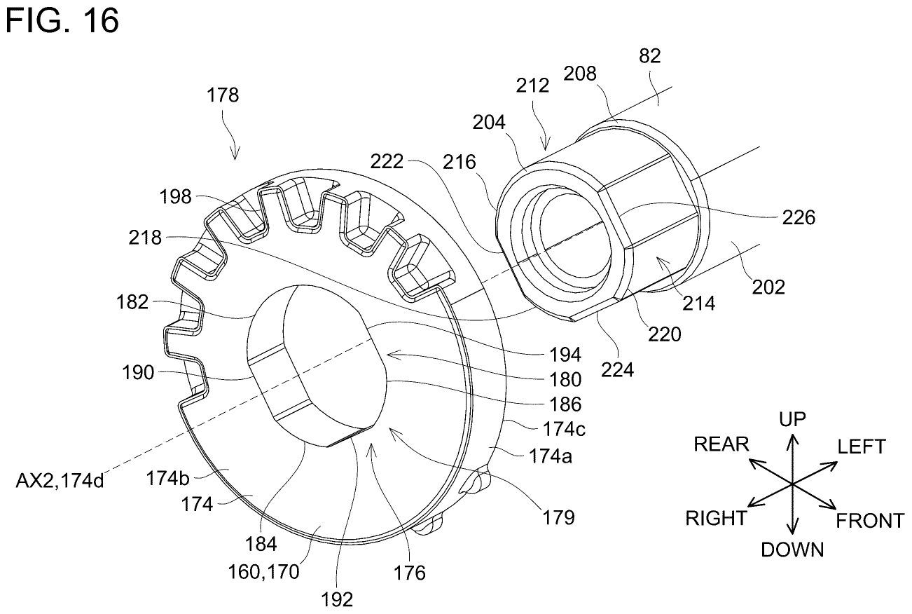

As shown in FIG. 16, each adjusting member 160 comprises a base part 174, an attaching part 176, and an adjusting part 178. The base part 174 has a substantially disk shape. The base part 174 comprises an outer peripheral surface 174a, a first side surface 174b, and a second side surface 174c. The outer peripheral surface 174a has a circular shape. A circle center 174d of the outer peripheral surface 174a is located on the central axis AX2. The outer peripheral surface 174a connects a rim of the first side surface 174b and a rim of the second side surface 174c. The first side surface 174b is opposite from the second side surface 174c.

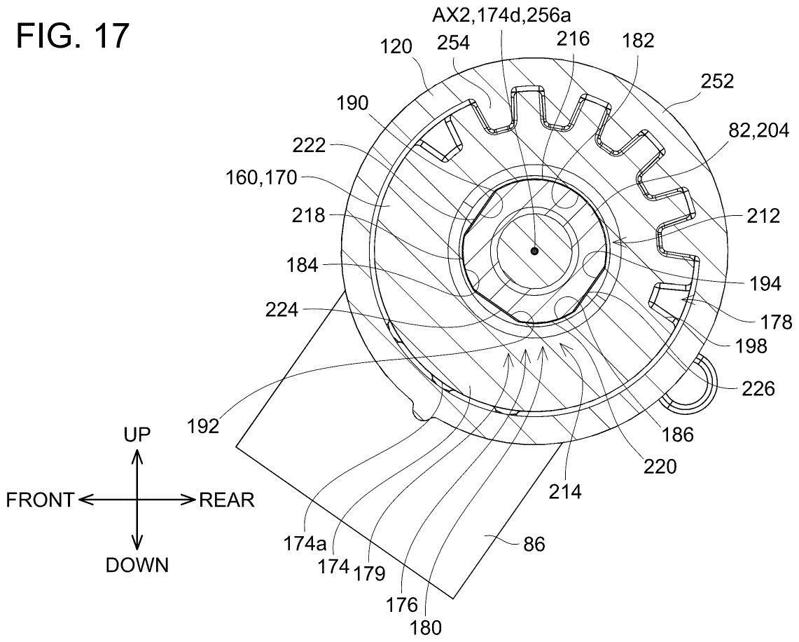

The attaching part 176 is a through hole. A cross-section of the attaching part 176 has a substantially circle shape in which plural parts of the circle are linear. The attaching part 176 penetrates the base part 174 from the first side surface 174b to the second side surface 174c in the left-right direction. As shown in FIG. 17, a center of the cross-section of the attaching part 176 is located on the circle center 174d of the outer peripheral surface 174a of the base part 174, that is, located on the central axis AX2. The attaching part 176 comprises an arc part 179 and a positioning part 180.

The arc part 179 comprises a first arc part 182, a second arc part 184, and a third arc part 186. The first arc part 182, the second arc part 184, and the third arc part 186 are disposed apart from each other. The first arc part 182, the second arc part 184, and the third arc part 186 share the same circle center 174d. A length of the first arc part 182 is longer than both of a length of the second arc part 184 and a length of the third arc part 186. The length of the second arc part 184 is substantially equal to the length of the third arc part 186.

The positioning part 180 comprises a first planar part 190, a second planar part 192, and a third planar part 194. The first planar part 190, the second planar part 192, and the third planar part 194 have a planar shape. The first planar part 190 is connected to one end of the first arc part 182 and one end of the second arc part 184. The second planar part 192 is connected to another end of the second arc part 184 and one end of the third arc part 186. The third planar part 194 is connected to another end of the third arc part 186 and another end of the first arc part 182.

The first planar part 190, the second planar part 192, and the third planar part 194 are disposed apart from each other. About the circle center 174d, an angle (90 degrees) between the first planar part 190 and the second planar part 192 is substantially equal to an angle (90 degrees) between the second planar part 192 and the third planar part 194. The first planar part 190 is substantially parallel to the third planar part 194. The second planar part 192 is inclined 90 degrees with respect to each of the first planar part 190 and the third planar part 194. A length about the circle center 174d of the first planar part 190 is substantially equal to each of a length about the circle center 174d of the second planar part 192, and a length about the circle center 174d of the third planar part 194.

As shown in FIG. 16, the adjusting part 178 is arranged at the outer peripheral surface 174a of the base part 174. The adjusting part 178 comprises a plurality of (seven in the present embodiment) receiving grooves 198. A cross section of each of the receiving grooves 198 has a substantially trapezoid shape. Each receiving groove 198 is recessed inward in a radial direction of the base part 174 from the outer peripheral surface 174a of the base part 174 toward the circle center 174d. The receiving grooves 198 are connected to the first side surface 174b of the base part 174. The receiving grooves 198 are not connected to the second side surface 174c of the base part 174.

The plurality of receiving grooves 198 is aligned at equal intervals about the central axis AX2. Adjacent receiving grooves 198 are apart from each other. The plurality of receiving grooves 198 is disposed about the central axis AX2 at a portion of the outer peripheral surface 174a of the base part 174 along a circumferential direction of the base part 174. In the receiving grooves 198, an interval between receiving grooves 198 disposed at opposing ends of the plurality of receiving grooves 198 about the central axis AX2 is 160 degrees.

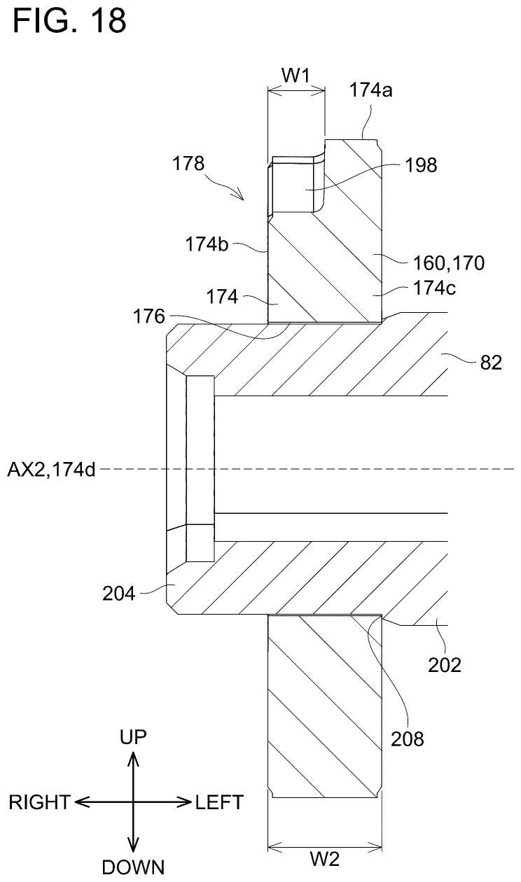

As shown in FIG. 18, in a direction along which the central axis AX2 extends (left-right direction), a width W1 of each receiving groove 198 is smaller than a distance between the first side surface 174b and the second side surface 174c, i.e., smaller than a width W2 of the base part 174. The width W1 is equal to or more than 30% and equal to or less than 70% of the width W2. Due to this, both of a strength of protrusions between each pair of the adjacent receiving grooves 198 and an entire strength of the adjusting members 160 can be suppressed from being excessively decreased. The width W1 may be equal to or more than 40% and equal to or less than 60% of the width W2. Due to this, both of the strength of the protrusions between each pair of the adjacent receiving grooves 198 and the entire strength of the adjusting members 160 can be further suppressed from being excessively decreased. In the present embodiment, the width W1 is 50% of the width W2.

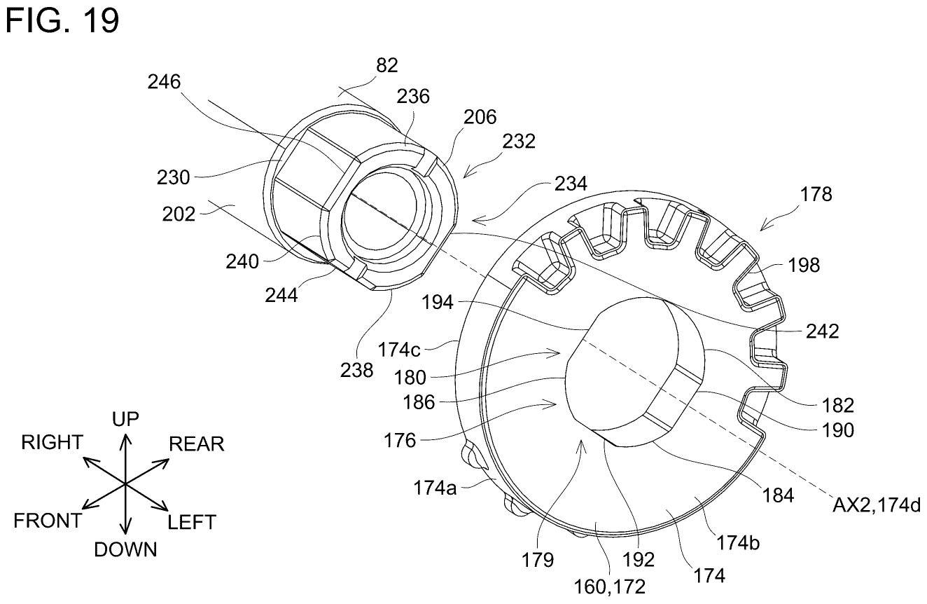

As shown in FIGS. 16 and 19, the first output shaft 82 comprises a central part 202, a right plate attaching part 204, and the left plate attaching part 206. As shown in FIG. 16, the right plate attaching part 204 is disposed to the right of the central part 202. The right plate attaching part 204 is located in vicinity of a right end of the first output shaft 82. The right plate attaching part 204 is inserted into the attaching part 176 of the first adjusting member 170. A cross section of an outer surface of the right plate attaching part 204 has a substantially circle shape in which a portion of the circle is linear. A diameter of the outer surface of the right plate attaching part 204 is smaller than a diameter of an outer surface of the central part 202. Due to this, a right step part 208 is disposed at a boundary between the right plate attaching part 204 and the central part 202. A cross-sectional shape of the right plate attaching part 204 has a shape corresponding to the cross-sectional shape of the attaching part 176 of the adjusting members 160. The right plate attaching part 204 comprises a right shaft arc part 212 and a right shaft positioning part 214.

As shown in FIG. 17, the right shaft arc part 212 comprises a right shaft arc part 216, a second right shaft arc part 218, and a third right shaft arc part 220. The first right shaft arc part 216, the second right shaft arc part 218, and the third right shaft arc part 220 are disposed apart from each other. A length of the first right shaft arc part 216 is substantially equal to a length of the first arc part 182. A length of the second right shaft arc part 218 is substantially equal to a length of the second arc part 184. A length of the third right shaft arc part 220 is substantially equal to a length of the third arc part 186.

The right shaft positioning part 214 comprises a first right shaft planar part 222, a second right shaft planar part 224, and a third right shaft planar part 226. The first right shaft planar part 222, the second right shaft planar part 224, and the third right shaft planar part 226 have a planar shape. The first right shaft planar part 222 is connected to one end of the first right shaft arc part 216 and one end of the second right shaft arc part 218. The second right shaft planar part 224 is connected to another end of the second right shaft arc part 218 and one end of the third right shaft arc part 220. The third right shaft planar part 226 is connected to another end of the third right shaft arc part 220 and another end of the first right shaft arc part 216.

An angle between the first right shaft planar part 222 and the second right shaft planar part 224 is substantially equal to an angle between the first planar part 190 and the second planar part 192. An angle between the second right shaft planar part 224 and the third right shaft planar part 226 is substantially equal to an angle between the second planar part 192 and the third planar part 194. The first right shaft planar part 222 is substantially parallel to the third right shaft planar part 226. The second right shaft planar part 224 is inclined 90 degrees with respect to each of the first right shaft planar part 222 and the third right shaft planar part 226. A length about the central axis AX2 of the first right shaft planar part 222 is substantially equal to a length about the circle center 174d of the first planar part 190. A length about the central axis AX2 of the second right shaft planar part 224 is substantially equal to a length about the circle center 174d of the second planar part 192. A length about the central axis AX2 of the third right shaft planar part 226 is substantially equal to a length about the circle center 174d of the third planar part 194.

When the right plate attaching part 204 is inserted into the attaching part 176 of the first adjusting member 170, the first right shaft arc part 216 is disposed to face the first arc part 182. The second right shaft arc part 218 is disposed to face the second arc part 184. The third right shaft arc part 220 is disposed to face the third arc part 186. The first right shaft planar part 222 is disposed to face the first planar part 190. The second right shaft planar part 224 is disposed to face the second planar part 192. The third right shaft planar part 226 is disposed to face the third planar part 194. The right shaft positioning part 214 is disposed at a specific position with respect to the positioning part 180, by which the first adjusting member 170 can be attached to the right plate attaching part 204 in a specific posture. Also, a wrong attachment of the first adjusting member 170 to the right plate attaching part 204 can be suppressed.

The first right shaft planar part 222 is in contact with the first planar part 190. The second right shaft planar part 224 is in contact with the second planar part 192. The third right shaft planar part 226 is in contact with the third planar part 194. When force about the central axis AX2 is applied on the first adjusting member 170 or the right plate attaching part 204, the first right shaft planar part 222 is pressed against the first planar part 190, the second right shaft planar part 224 is pressed against the second planar part 192, and the third right shaft planar part 226 is pressed against the third planar part 194. Due to this, the first adjusting member 170 can be suppressed from rotating about the central axis AX2 relative to the right plate attaching part 204.

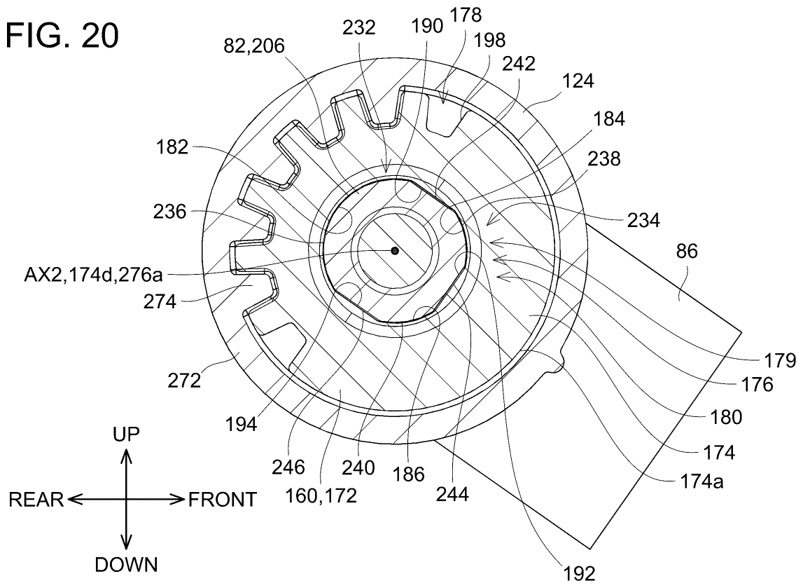

As shown in FIG. 19, the left plate attaching part 206 is disposed to the left of the central part 202. The left plate attaching part 206 is located in vicinity of a left end of the first output shaft 82. The left plate attaching part 206 is inserted into the attaching part 176 of the second adjusting member 172. A cross-section of an outer surface of the left plate attaching part 206 has a substantially circle shape in which a portion of the circle is linear. A diameter of the outer surface of the left plate attaching part 206 is smaller than a diameter of an outer surface of the central part 202. Due to this, a left step part 230 is defined at a boundary between the left plate attaching part 206 and the central part 202. A cross-sectional shape of the left plate attaching part 206 has a shape corresponding to the cross-sectional shape of the attaching part 176 of the adjusting member 160. The cross-sectional shape of the left plate attaching part 206 is plane-symmetrical with respect to each of the cross-sectional shape of the right plate attaching part 204 and a plane perpendicular to the central axis AX2. That is, the left plate attaching part 206 comprises a left shaft arc part 232 and a left shaft positioning part 234. Likewise, as shown in FIG. 20, the left shaft arc part 232 comprises a first left shaft arc part 236, a second left shaft arc part 238, and a third left shaft arc part 240. Further, the left shaft positioning part 234 comprises a first left shaft planar part 242, a second left shaft planar part 244, and a third left shaft planar part 246.

When the left plate attaching part 206 is inserted into the attaching part 176 of the second adjusting member 172, the first left shaft arc part 236 is disposed to face the first arc part 182. The second left shaft arc part 238 is disposed to face the second arc part 184. The third left shaft arc part 240 is disposed to face the third arc part 186. The first left shaft planar part 242 is disposed to face the first planar part 190. The second left shaft planar part 244 is disposed to face the second planar part 192. The third left shaft planar part 246 is disposed to face the third planar part 194. The left shaft positioning part 234 is disposed at a specific position with respect to the positioning part 180, by which the second adjusting member 172 can be attached to the left plate attaching part 206 in a specific posture. Also, a wrong attachment of the second adjusting member 172 to the left plate attaching part 206 can be suppressed.

The first left shaft planar part 242 is in contact with the first planar part 190. The second left shaft planar part 244 is in contact with the second planar part 192. The third left shaft planar part 246 is in contact with the third planar part 194. When the force about the central axis AX2 is applied on the second adjusting member 172 or the left plate attaching part 206, the first planar part 190 is pressed against the first left shaft planar part 242, the second planar part 192 is pressed against the second left shaft planar part 244, and the third planar part 194 is pressed against the third left shaft planar part 246. Due to this, the second adjusting member 172 can be suppressed from rotating about the central axis AX2 relative to the left plate attaching part 206.

The cross-sectional shape of the left plate attaching part 206 is plane-symmetrical with respect to each of the cross-sectional shape of the right plate attaching part 204 and the plane perpendicular to the central axis AX2. Due to this, an attaching posture of the first adjusting member 170 relative to the first output shaft 82 is substantially the same as an attaching posture of the second adjusting member 172 relative to the first output shaft 82.

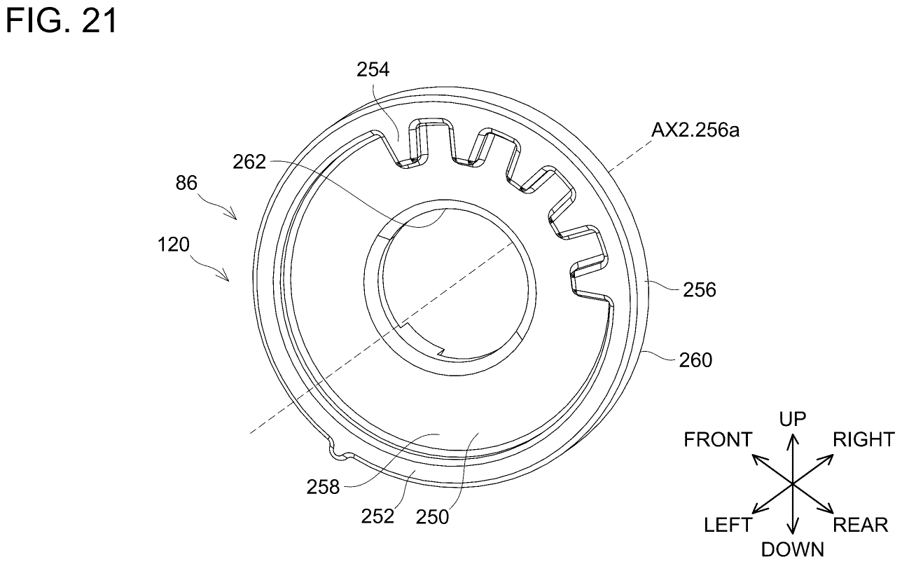

As shown in FIG. 21, the right attaching part 120 of the blade 86 comprises a right disk part 250, a right peripheral wall part 252, and a plurality of (five in the present embodiment) right protrusions 254.

The right disk part 250 has a substantially circular plate shape. The right disk part 250 comprises an outer peripheral surface 256, a first side surface 258, and a second side surface 260. The outer peripheral surface 256 has a circle shape. A circle center 256a of the outer peripheral surface 256 is located on the central axis AX2. The outer peripheral surface 256 connects a rim of the first side surface 258 and a rim of the second side surface 260. The first side surface 258 is opposite from the second side surface 260. The right disk part 250 has an insertion hole 262. The insertion hole 262 penetrates the right disk part 250 from the first side surface 258 to the second side surface 260 in the left-right direction. A center of a cross-section of the insertion hole 262 is located on the circle center 256a of the outer peripheral surface 256. The insertion hole 262 has the right plate attaching part 204 (see FIG. 9) inserted therethrough. At this time, the first side surface 258 faces the first side surface 174b (see FIG. 16) of the first adjusting member 170.

The right peripheral wall part 252 protrudes leftward from the rim of the first side surface 258. The right peripheral wall part 252 surrounds an entirety of the rim of the first side surface 258. The right peripheral wall part 252 has a substantially circular cylinder shape.

Each of the right protrusions 254 has a substantially trapezoid shape. Each of the right protrusions 254 protrudes inward in a radial direction of the right disk part 250 from an inner peripheral surface of the right peripheral wall part 252 toward the central axis AX2. The right protrusions 254 are connected to the first side surface 258.

The plurality of right protrusions 254 is aligned at equal intervals about the central axis AX2. Adjacent right protrusions 254 are apart from each other. The plurality of right protrusions 254 is disposed about the central axis AX2 at a portion of the inner peripheral surface of the right peripheral wall part 252 along a circumferential direction of the right peripheral wall part 252. As shown in FIG. 17, an interval about the central axis AX2 between the adjacent right protrusions 254 is substantially equal to an interval about the central axis AX2 between the adjacent receiving grooves 198. The right protrusions 254 are received in the receiving grooves 198. At this time, the first adjusting member 170 is disposed inside the right peripheral wall part 252. A number of the plurality of right protrusions 254 is less than a number of the plurality of receiving grooves 198. Due to this, the attaching posture of the right attaching part 120 relative to the first adjusting member 170 can be adjusted by changing a position of the plurality of right protrusions 254 relative to the plurality of receiving grooves 198.

As shown in FIG. 9, the right attaching part 120 is attached to the first adjusting member 170 from the right. The right attaching part 120, the first adjusting member 170, and the other end of the right connection part 118 are interposed outside the front-end housing 40 between the bolt 126 and the right step part 208. Due to this, the attaching posture of the right attaching part 120 relative to the first adjusting member 170 is fixed. Also, the bolt 126 is in contact with the right attaching part 120, the first adjusting member 170, and the other end of the right connection part 118. Due to this, the right attaching part 120, the first adjusting member 170, and the other end of the right connection part 118 can be suppressed from slipping out of the right plate attaching part 204.

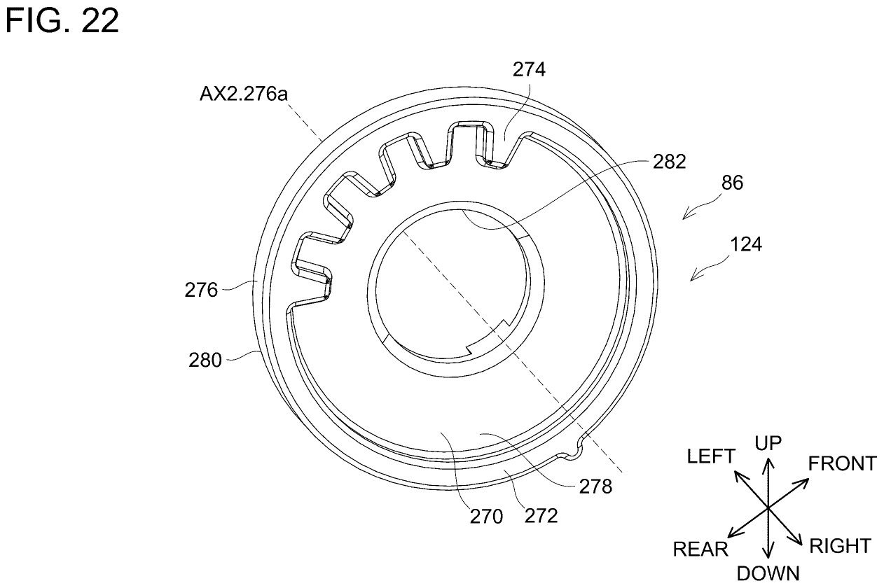

As shown in FIG. 22, a shape of the left attaching part 124 of the blade 86 is plane-symmetrical with respect to the right attaching part 120 of the blade 86 and the plane perpendicular to the central axis AX2. That is, the left attaching part 124 comprises a left disk part 270, a left peripheral wall part 272, and a plurality of (five in the present embodiment) left protrusions 274. A number of the plurality of left protrusions 274 is identical to the number of the plurality of right protrusions 254 (see FIG. 21). The left disk part 270 comprises an outer peripheral surface 276, a first side surface 278, and a second side surface 280. The left disk part 270 has an insertion hole 282. A center of a cross section of the insertion hole 282 is disposed on a circle center 276a of the outer peripheral surface 276. As shown in FIG. 20, the left protrusions 274 are received in the receiving grooves 198. Due to this, the attaching posture of the left attaching part 124 relative to the second adjusting member 172 can be adjusted by changing a position of the plurality of left protrusions 274 relative to the plurality of receiving grooves 198.

As shown in FIG. 9, the left attaching part 124 is attached to the second adjusting member 172 from the left. The left attaching part 124, the second adjusting member 172, and the other end of the left connection part 122 are interposed outside the front-end housing 40 between the bolt 130 and the left step part 230. Due to this, the attaching posture of the left attaching part 124 relative to the second adjusting member 172 is fixed. Also, the bolt 130 is in contact with the left attaching part 124, the second adjusting member 172, and the other end of the left connection part 122. Due to this, the left attaching part 124, the second adjusting member 172, and the other end of the left connection part 122 can be suppressed from slipping out of the left plate attaching part 206.

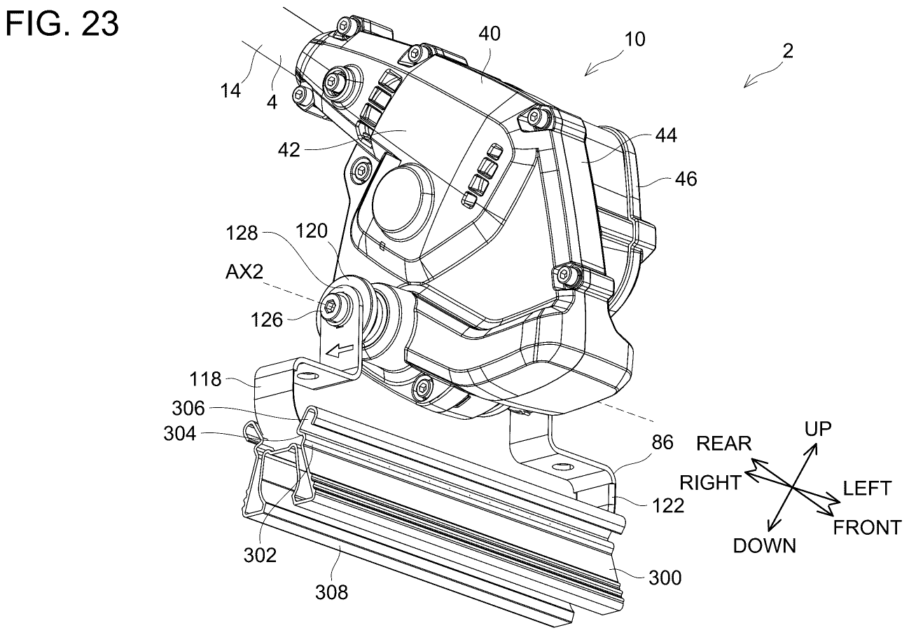

As shown in FIG. 23, the working machine 2 comprises a blade cover 300. The blade cover 300 is constituted of a resin material. The blade cover 300 is attached to the blade 86. The blade cover 300 covers the blade part 116 of the blade 86. Due to this, for example, the blade part 116 can be suppressed from coming into contact with a user while the working machine 2 is stored and/or while the working machine 2 is being carried. Also, the blade cover 300 is disposed apart from the front-end housing 40. Hereafter, description will be made with the coordinate system to the following coordinate system. Specifically, a longitudinal direction of the blade part 116 will be referred to as a left-right direction, a direction perpendicular to the left-right direction will be referred to as a front-rear direction, and a direction perpendicular to the left-right direction and the front-rear direction will be referred to as an up-down direction. The blade part 116 is disposed along a plane including the left-right direction and the front-rear direction.

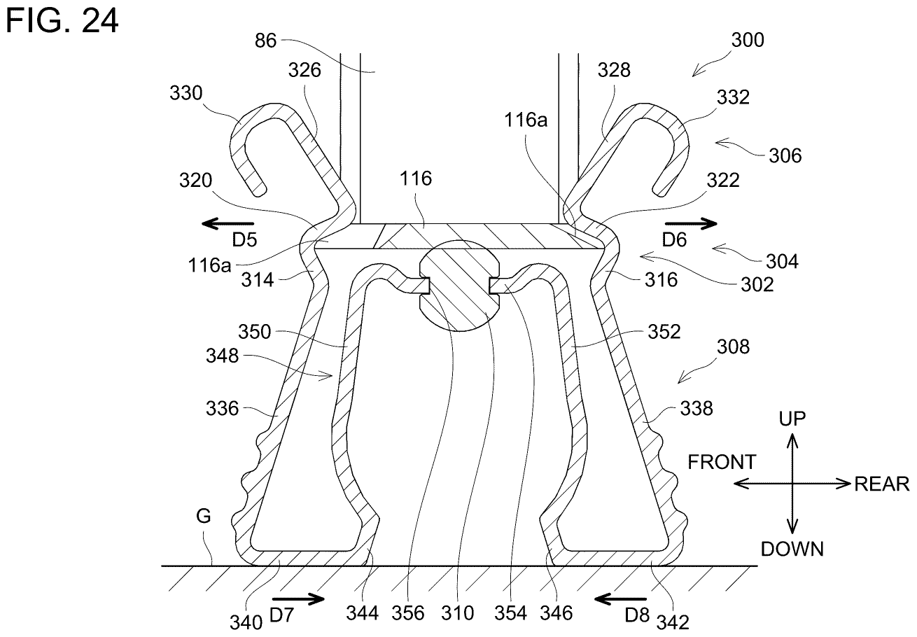

The blade cover 300 extends in the left-right direction. A cross-sectional shape of the blade cover 300 is substantially the same in the left-right direction. Due to this, the blade cover 300 is manufactured by extrusion molding for example. As shown in FIG. 24, when the blade cover 300 is attached to the blade part 116, a lower surface of the blade part 116 is substantially parallel to the ground G. The blade cover 300 comprises a cover part 302, a contact part 304, a guide part 306, a releasing part 308, and a friction force applying part 310.

The cover part 302 covers the blade part 116. The cover part 302 comprises a first cover part 314 and a second cover part 316. The first cover part 314 is disposed on the front side relative to the second cover part 316. The first cover part 314 is disposed apart from the second cover part 316 in the front-rear direction. The first cover part 314 and the second cover part 316 are disposed to face each other in the front-rear direction. The first cover part 314 extends front-and-upward from its lower end. The second cover part 316 extends rear-and-upward from its lower end. Due to this, a distance in the front-rear direction between the first cover part 314 and the second cover part 316 increases from the lower ends to upper ends of the first cover part 314 and the second cover part 316. A maximum distance in the front-rear direction between the first cover part 314 and the second cover part 316 is longer than a length in the front-rear direction of the blade part 116. The first cover part 314 covers the plurality of teeth 116a at the front end of the blade part 116. The second cover part 316 covers the plurality of teeth 116a at the rear end of the blade part 116.

The contact part 304 is disposed above the blade part 116. The contact part 304 comprises a first contact part 320 and a second contact part 322. The first contact part 320 is disposed above the plurality of teeth 116a at the front end of the blade part 116. The second contact part 322 is disposed above the plurality of teeth 116a at the rear end of the blade part 116. The first contact part 320 is disposed on the front side relative to the second contact part 322. The first contact part 320 is connected to an upper end of the first cover part 314. The second contact part 322 is connected to an upper end of the second cover part 316. The first contact part 320 is disposed apart from the second contact part 322 in the front-rear direction. The first contact part 320 is disposed to face the second contact part 322 in the front-rear direction. The first contact part 320 extends rear-and-upward from its lower end. The second contact part 322 extends front-and-upward from its lower end. Due to this, a distance in the front-rear direction between the first contact part 320 and the second contact part 322 decreases from the lower ends to upper ends of the first contact part 320 and the second contact part 322. A minimum distance in the front-rear direction between the first contact part 320 and the second contact part 322 is smaller than a length in the front-rear direction of the blade part 116. The first contact part 320 and the second contact part 322 are configured such that when the blade part 116 moves upward relative to the blade cover 300 the blade part 116 comes into contact with the first contact part 320 and the second contact part 322. Due to this, the cover part 302 is maintained in the state of covering the blade part 116.

The guide part 306 comprises a first guide part 326, a second guide part 328, a first bent part 330, and a second bent part 332. The first guide part 326 is disposed on the front side relative to the second guide part 328. The first guide part 326 is connected to an upper end of the first contact part 320. The second guide part 328 is connected to an upper end of the second contact part 322. The first guide part 326 is disposed apart from the second guide part 328 in the front-rear direction. The first guide part 326 is disposed to face the second guide part 328 in the front-rear direction. The first guide part 326 extends front-and-upward from a lower end of the first guide part 326. The second guide part 328 extends rear-and-upward from a lower end of the second guide part 328. Due to this, a distance in the front-rear direction between the first guide part 326 and the second guide part 328 gradually increases from lower ends to upper ends of the first guide part 326 and the second guide part 328.

The first bent part 330 is connected to the upper end of the first guide part 326. The second bent part 332 is connected to the upper end of the second guide part 328. The first bent part 330 extends front-and-downward from the upper end of the first guide part 326 and then bends to extend rear-and-downward. The second bent part 332 extends rear-and-downward from the upper end of the second guide part 328 and then bends to extend front-and-downward. Due to this, an end of the guide part 306 can be suppressed from coming into contact with the user.

The releasing part 308 is elastically deformable. The releasing part 308 comprises a first operating part 336, a second operating part 338, a first placement part 340, a second placement part 342, a third guide part 344, a fourth guide part 346, and an attaching part 348. The first operating part 336 is disposed on the front side relative to the second operating part 338. The first operating part 336 is connected to a lower end of the first cover part 314. The second operating part 338 is connected to a lower end of the second cover part 316. The first operating part 336 is disposed apart from the second operating part 338 in the front-rear direction. The first operating part 336 extends front-and-downward from its upper end. The second operating part 338 extends rear-and-downward from its upper end. Due to this, a distance in the front-rear-direction between the first operating part 336 and the second operating part 338 increases from the upper ends to lower ends of the first operating part 336 and the second operating part 338.

The first placement part 340 and the second placement part 342 are planar. The first placement part 340 is disposed on the front side relative to the second placement part 342. The first placement part 340 is connected to the lower end of the first operating part 336. The second placement part 342 is connected to the lower end of the second operating part 338. The first placement part 340 is disposed apart from the second placement part 342 in the front-rear direction. The first placement part 340 extends rearward from the lower end of the first operating part 336. The second placement part 342 extends frontward from the lower end of the second operating part 338. The first placement part 340 and the second placement part 342 are disposed on a same plane. When the blade cover 300 is placed on the ground G, the first placement part 340 and the second placement part 342 are in contact with the ground G. The first placement part 340 and the second placement part 342 are substantially parallel to the ground G. The first placement part 340 and the second placement part 342 have their surfaces in contact with the ground G. Due to this, the blade cover 300 on the ground G can be suppressed from falling.

The third guide part 344 is disposed on the front side relative to the fourth guide part 346. The third guide part 344 is connected to a rear end of the first placement part 340. The fourth guide part 346 is connected to a front end of the second placement part 342. The third guide part 344 is disposed apart from the fourth guide part 346 in the front-rear direction. The third guide part 344 is disposed to face the fourth guide part 346 in the front-rear direction. The third guide part 344 extends rear-and-upward from the rear end of the first placement part 340. The fourth guide part 346 extends front-and-upward from the front end of the second placement part 342. A distance in the front-rear direction between the third guide part 344 and the fourth guide part 346 gradually decreases from the lower ends to the upper ends of the third guide part 344 and the fourth guide part 346.

The attaching part 348 is connected to an upper end of the third guide part 344 and an upper end of the fourth guide part 346. The attaching part 348 comprises a first attaching part 350, a second attaching part 352, and a third attaching part 354. The first attaching part 350 is disposed on the front side relative to the second attaching part 352. The first attaching part 350 is connected to the upper end of the third guide part 344. The second attaching part 352 is connected to the upper end of the fourth guide part 346. The first attaching part 350 is disposed apart from the second attaching part 352 in the front-rear direction. The first attaching part 350 is disposed to face the second attaching part 352 in the front-rear direction. The first attaching part 350 extends front-and-upward from the lower end thereof and then bends to extend rear-and-upward. The second attaching part 352 extends rear-and-upward from the lower end thereof and then bends to extend front-and-upward.

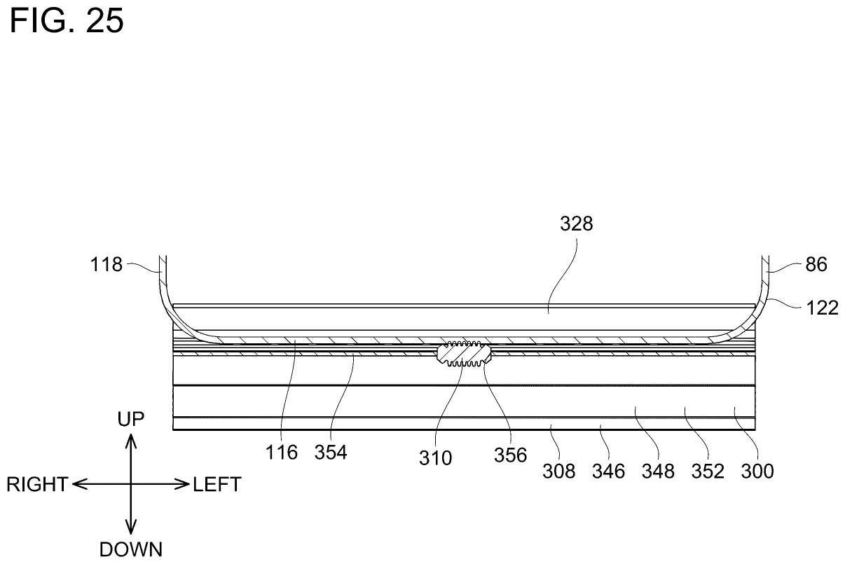

The third attaching part 354 connects the upper end of the first attaching part 350 and the upper end of the second attaching part 352. The third attaching part 354 extends substantially in the front-rear direction. The third attaching part 354 is substantially parallel to each of the ground G and the lower surface of the blade part 116. The third attaching part 354 has an insertion hole 356. The insertion hole 356 penetrates the third attaching part 354 in its thickness direction (up-down direction). As shown in FIG. 25, the insertion hole 356 is disposed at a center in a longitudinal direction of the third attaching part 354.

The friction force applying part 310 is constituted of, for example, an elastic material. The friction force applying part 310 is for example friction rubber. The friction force applying part 310 is inserted into the insertion hole 356. The friction force applying part 310 is fixed to the third attaching part 354. The friction force applying part 310 penetrates upward from the insertion hole 356 and also penetrates downward from the insertion hole 356.

With the blade cover 300 attached to the blade part 116, an upper portion of the friction force applying part 310 is in contact with the lower surface of the blade part 116. When force of the blade cover 300 sliding leftward relative to the blade part 116 is applied on the blade part 116 or the blade cover 300, the friction force applying part 310 applies rightward friction force (friction force opposite from leftward) relative to the blade part 116 on the blade part 116. When force of the blade cover 300 sliding rightward relative to the blade part 116 is applied on the blade part 116 or the blade cover 300, the friction force applying part 310 applies leftward friction force (friction force opposite from rightward) relative to the blade part 116 on the blade part 116. Due to this, the blade cover 300 can be suppressed from sliding relative to the blade part 116 in the left-right direction. Due to this, the blade cover 300 can be suppressed from sliding relative to the blade part 116 in the left-right direction due to a self-weight of the blade cover 300 for example, thus the blade cover 300 can be suppressed from being detached from the blade part 116. Also, wobbling of the blade cover 300 relative to the blade part 116 can be suppressed.

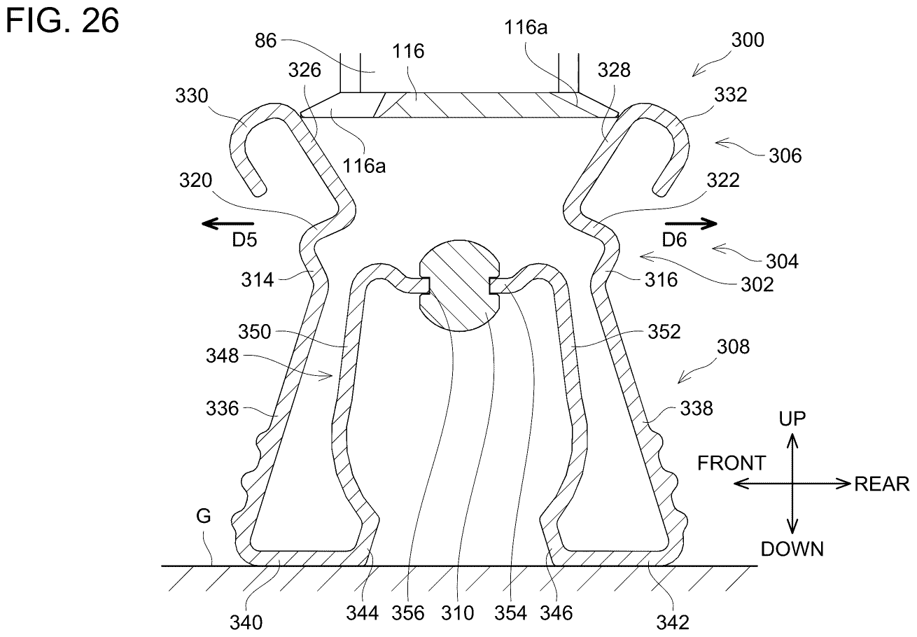

The blade cover 300 according to the present embodiment can be attached to the blade part 116 in three ways. As shown in FIG. 26, a user, with the blade cover 300 placed on the ground G, grips the working machine 2 (see FIG. 24) and moves the blade part 116 downward from above the first guide part 326 and the second guide part 328. Due to this, the blade cover 300 is elastically deformed, by which the first guide part 326 and the second guide part 328 are moved farther away from each other in the front-rear direction. That is, the first guide part 326 moves from an initial position in a separating direction D5, whereas on the other hand, the second guide part 328 moves from an initial position in a separating direction D6 opposite from the separating direction D5. Due to this, the first contact part 320 and the second contact part 322 are moved away from each other in the front-rear direction. When the user has moved the blade part 116 to below a lower end of the first guide part 326 and a lower end of the second guide part 328, elastic restoring force of the blade cover 300 causes the first guide part 326 and the second guide part 328 to approach each other in the front-rear direction. The first guide part 326 moves to the initial position in the opposite direction from the separating direction D5, whereas the second guide part 328 moves to the initial position in the opposite direction from the separating direction D6. Due to this, the first contact part 320 and the second contact part 322 approach each other in the front-rear direction, by which the first contact part 320 and the second contact part 322 are positioned above the teeth 116a of the blade part 116. The user can easily attach the blade cover 300 to the blade part 116 with a simple operation of pressing the blade part 116 on the blade cover 300 from above.

Also, the user applies force counteracting the elastic restoring force of the releasing part 308 on the releasing part 308 by gripping the blade cover 300. Specifically, the user operates the first operating part 336 and the second operating part 338 in a direction along which the first operating part 336 and the second operating part 338 approach each other. Due to elastic deformation of the releasing part 308, the first operating part 336 moves from an initial position in an approaching direction D7, whereas the second operating part 338 moves from an initial position in an approaching direction D8 opposite from the approaching direction D7. Along with moving of the first operating part 336 and the second operating part 338, the first guide part 326 moves from the initial position in the separating direction D5 whereas the second guide part 328 moves from the initial position in the separating direction D6 opposite from the separating direction D5. Due to this, the first contact part 320 and the second contact part 322 are moved away from each other in the front-rear direction. Next, the user moves the blade cover 300 upward relative to the blade part 116. Due to this, the user can easily attach the blade cover 300 to the blade part 116 with a simple operation of operating the first operating part 336 and the second operating part 338.

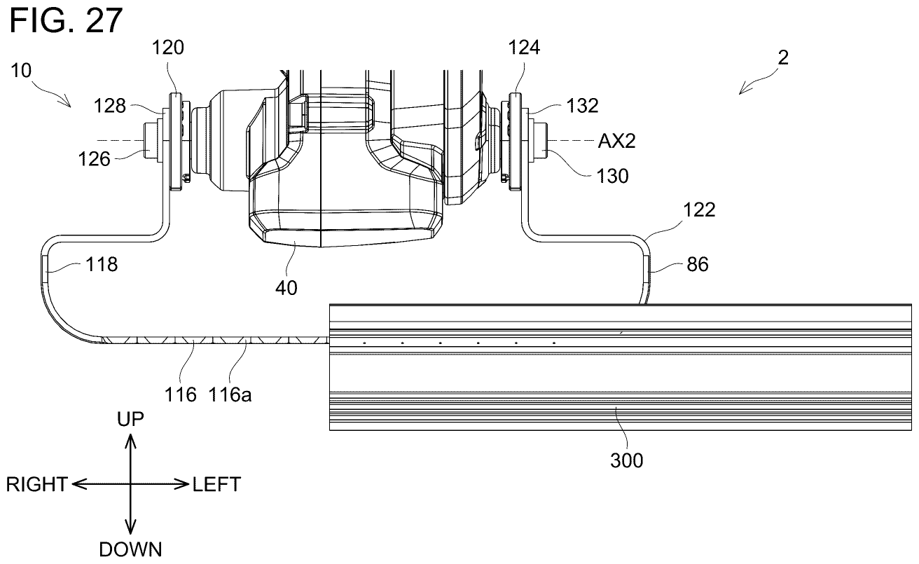

When the user grips the blade cover 300 by hand and moves the blade cover 300 leftward (or rightward) relative to the blade part 116 so as to be closer to the blade part 116 as shown in FIG. 27, the blade part 116 moves leftward (or rightward) between the cover part 302 and the contact part 304. Due to this, the user can easily attach the blade cover 300 to the blade part 116 with a simple operation of sliding the blade cover 300 relative to the blade part 116 in the left-right direction.

The blade cover 300 according to the present embodiment can be detached from the blade part 116 in two ways. As shown in FIG. 24, the user grips the blade cover 300 and thus applies force counteracting the elastic restoring force of the releasing part 308 on the releasing part 308. Specifically, the user operates the first operating part 336 and the second operating part 338 in a direction along which the first operating part 336 and the second operating part 338 approach each other. Due to elastic deformation of the releasing part 308, the first operating part 336 moves from the initial position in the approaching direction D7 whereas the second operating part 338 moves from the initial position in the approaching direction D8 opposite from the approaching direction D7. Along with moving of the first operating part 336 and the second operating part 338, the first guide part 326 moves from the initial position in the separating direction D5 whereas the second guide part 328 moves from the initial position in the separating direction D6 opposite from the separating direction D5. Due to this, the first contact part 320 and the second contact part 322 are moved away from each other in the front-rear direction. Next, when the user moves the blade part 116 upward relative to the blade cover 300, the blade cover 300 is detached from the blade part 116. Due to this, the user can detach the blade cover 300 from the blade part 116 with a simple operation of operating the first operating part 336 and the second operating part 338.

As shown in FIG. 27, with the blade cover 300 attached to the blade part 116, the user grips the blade cover 300 by hand, and moves the blade cover 300 leftward (or rightward) relative to the blade part 116. The user can easily detach the blade cover 300 from the blade part 116 with a simple operation of sliding the blade cover 300 relative to the blade part 116 in the left-right direction.

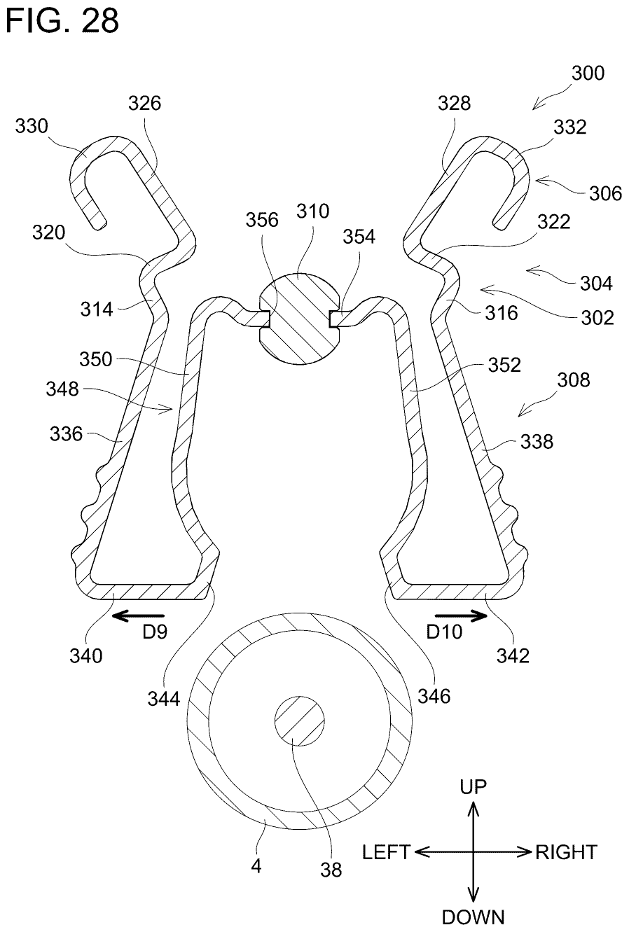

The blade cover 300 according to the present embodiment can be attached to the pole 4 of the working machine 2. As shown in FIG. 28, a minimum distance between the third guide part 344 and the fourth guide part 346 in the front-rear direction is shorter than a diameter of the pole 4. When the user grips the blade cover 300 by hand and moves the third guide part 344 and the fourth guide part 346 downward from above the pole 4, the releasing part 308 elastically deforms, by which the third guide part 344 and the fourth guide part 346 are moved away from each other in the front-rear direction. That is, the third guide part 344 moves from the initial position in a separating direction D9 whereas the fourth guide part 346 moves from the initial position in a separating direction D10 opposite from the separating direction D9. When the pole 4 has moved into the attaching part 348, due to elastic restoring force the releasing part 308, the third guide part 344 and the fourth guide part 346 approach each other in the front-rear direction. The third guide part 344 moves to the initial position in an opposite direction from the separating direction D9 toward to the initial position, whereas the fourth guide part 346 moves in an opposite direction from the separating direction D10 toward the initial position. The user can easily attach the blade cover 300 to the pole 4 with a simple operation.

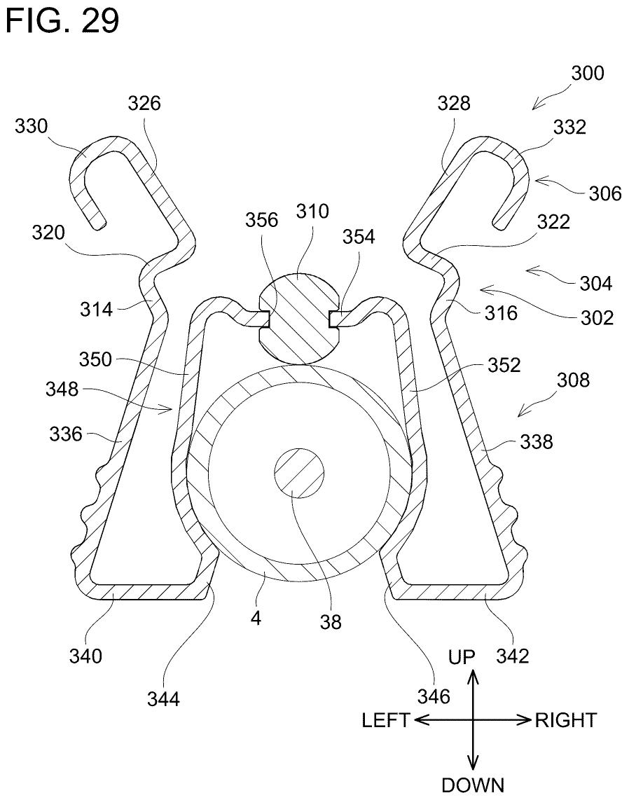

As shown in FIG. 29, with the blade cover 300 attached to the pole 4, the attaching part 348 surrounds the pole 4. The attaching part 348 is pressed against the pole 4 due to elastic restoring force of the releasing part 308. Due to this, the blade cover 300 can be suppressed from being detached from the pole 4.

### (Effects)

The working machine 2 according to the present embodiment comprises: the motor 20 (example for a prime mover); the first output shaft 82 (example for an output shaft) configured to move by movement of the motor 20; the first adjusting member 170 detachably attached to the first output shaft 82; and the blade 86 (example for a working member) detachably attached to the first adjusting member 170. The first adjusting member 170 comprises: the attaching part 176 attached to the first output shaft 82, and the adjusting part 178 attached to the blade 86 and configured to adjust the attaching posture of the blade 86 relative to the first adjusting member 170.

According to the above configuration, the first output shaft 82 and the first adjusting member 170 can be processed separately. Due to this, the attaching posture of the blade 86 relative to the first adjusting member 170 can be adjusted by using the first output shaft 82 and the first adjusting member 170 that are easy to process.

The first output shaft 82 comprises the right shaft positioning part 214 (example for a first shaft positioning part). The attaching part 176 comprises the positioning part 180 disposed at a specific position relative to the right shaft positioning part 214 when the first output shaft 82 is attached to the attaching part 176.

According to the above configuration, by way of a simple method of arranging the positioning part 180 at a specific position relative to the right shaft positioning part 214, the attaching part 176 can be positioned at the specific position relative to the first output shaft 82.

The first output shaft 82 is inserted into the attaching part 176. The right shaft positioning part 214 is disposed on the outer surface of the first output shaft 82. The positioning part 180 is disposed to face the right shaft positioning part 214 when the first output shaft 82 is inserted into the attaching part 176.

According to the above configuration, the attaching part 176 can be easily disposed at the specific position relative to the first output shaft 82 by inserting the first output shaft 82 into the attaching part 176 with the right shaft positioning part 214 facing the positioning part 180.

The right shaft positioning part 214 comprises the first right shaft planar part 222 (example for a first shaft planar part) having a planar shape. The positioning part 180 comprises the first planar part 190 having a planar shape and configured to face and contact the right shaft planar part 222 when the first output shaft 82 is inserted into the attaching part 176.

According to the above configuration, when force about the first output shaft 82 is applied on the first adjusting member 170, the first planar part 190 is pressed against the first right shaft planar part 222. Due to this, the first adjusting member 170 can be suppressed from rotating about the first output shaft 82.

The right shaft positioning part 214 further comprises the second right shaft planar part 224 (example for a second shaft planar part) having a planar shape. The positioning part 180 further comprises the second planar part 192 having a planar shape and configured to face and contact the second right shaft planar part 224 when the first output shaft 82 is inserted into the attaching part 176.

According to the above configuration, when the force about the first output shaft 82 is applied on the first adjusting member 170, the first planar part 190 is pressed against the first right shaft planar part 222, and the second planar part 192 is pressed against the second right shaft planar part 224. Due to this, the first adjusting member 170 can be further suppressed from rotating about the first output shaft 82.

The blade 86 is configured to swing about the central axis AX2 (example for a swing axis) by movement of the first output shaft 82.

According to the above configuration, in the configuration where the blade 86 swings, the attaching posture of the blade 86 relative to the first adjusting member 170 needs to be adjusted in accordance with a posture in which the user works. In the configuration where the blade 86 swings as mentioned above, the attaching posture of the blade 86 relative to the first adjusting member 170 can be adjusted by using the first output shaft 82 and the first adjusting member 170 that are easy to process.

The first adjusting member 170 includes the outer peripheral surface 174a having a circular shape with a center on the central axis AX2. The adjusting part 178 is disposed at a portion of the outer peripheral surface 174a of the first adjusting member 170 along the circumferential direction of the first adjusting member 170.

In a configuration where the adjusting part 178 is disposed on an entirety of the outer peripheral surface 174a of the first adjusting member 170 along the circumferential direction of the first adjusting member 170, while the blade 86 is being attached at a certain position relative to the first adjusting member 170, the blade 86 may come into contact with a component of the working machine 2, for example, the front-end housing 40 during work. According to the above configuration, because the adjusting part 178 is disposed at a portion of the outer peripheral surface 174a of the first adjusting member 170 along the circumferential direction of the first adjusting member 170, the blade 86 can be suppressed from coming into contact with, a component of the working machine 2, e.g., the front-end housing 40, during work.

In a leftward direction (example for a first direction) along which the central axis AX2 extends, the width W1 of the adjusting part 178 is equal to or more than 30% and equal to or less than 70% of the width W2 of the first adjusting member 170.

According to the above configuration, both of a strength of the adjusting part 178 and a strength of an entirety of the first adjusting member 170 can be suppressed from being excessively decreased.

The adjusting part 178 comprises the plurality of receiving grooves 198 aligned about the central axis AX2. The blade 86 comprises the plurality of right protrusions 254 (example for protrusions) aligned about the central axis AX2. Each of the right protrusions 254 is configured to be received in a corresponding one of the receiving grooves 198. A number of the plurality of right protrusions 254 is less than a number of the plurality of receiving grooves 198.

According to the above configuration, the attaching posture of the blade 86 relative to the first adjusting member 170 can be easily adjusted by modifying a position of the plurality of protrusions 254 relative to the plurality of receiving grooves 198.

### Second Embodiment

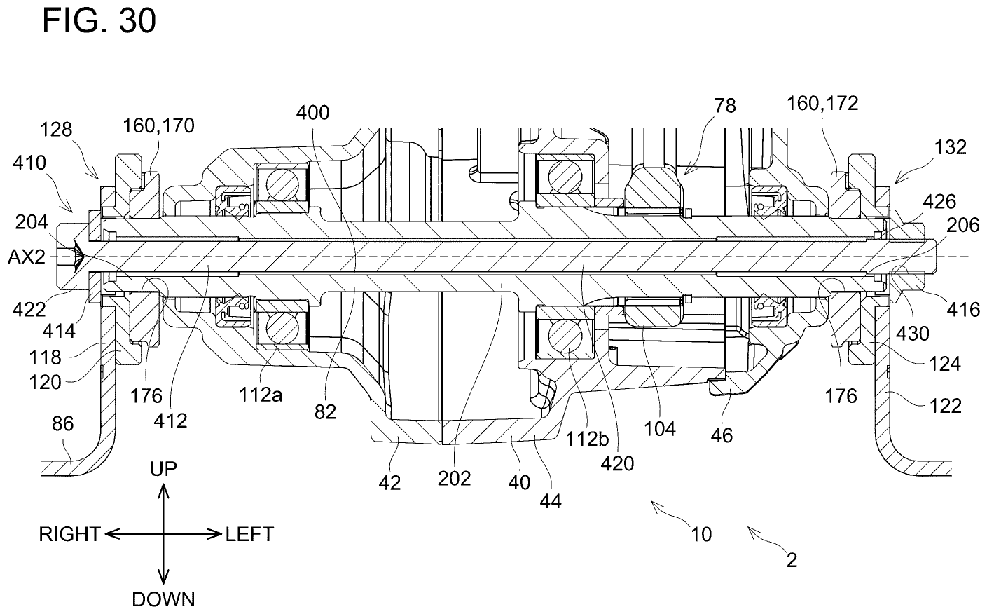

In a second embodiment, only the points different from the first embodiment will be described. As shown in FIG. 30, a first output shaft 82 is rotatably supported by a front-end housing 40 via a bearing 112a and a bearing 112b. Also, the first output shaft 82 extends in the left-right direction. The first output shaft 82 penetrates the front-end housing 40 in the left-right direction. A right plate attaching part 204 positioned at a right end of the first output shaft 82 and a left plate attaching part 206 positioned at a left end of the first output shaft 82 are arranged outside the front-end housing 40.

The first output shaft 82 has a hollow shape. The first output shaft 82 has a shaft through hole 400 extending in the left-right direction. The shaft through hole 400 is defined by an inner surface of the first output shaft 82. The shaft through hole 400 penetrates the first output shaft 82 in the left-right direction. The shaft through hole 400 has a substantially circular columnar shape.

A first adjusting member 170 is attached to the right plate attaching part 204 by the right plate attaching part 204 penetrating an attaching part 176 of the first adjusting member 170. The first adjusting member 170 is an example for a first intermediate member. A right attaching part 120 of a first portion 128 of a blade 86 is attached to the first adjusting member 170. The first portion 128 is positioned at one end of the blade 86. The first portion 128 has a right end of the first output shaft 82, that is, the right plate attaching part 204 inserted therethrough. A diameter of an opening of the first portion 128 is larger than a diameter of the right plate attaching part 204. The first portion 128 is not in contact with the right plate attaching part 204. The first portion 128 is disposed at the right end of the first output shaft 82. An attaching posture of the blade 86 relative to the first adjusting member 170 is adjusted by an attaching posture of the right attaching part 120 relative to the first adjusting member 170 being adjusted.

A second adjusting member 172 is attached to the left plate attaching part 206 by the left plate attaching part 206 penetrating an attaching part 176 of the second adjusting member 172. The second adjusting member 172 is an example for a second intermediate member. A left attaching part 124 of a second portion 132 of the blade 86 is attached to the second adjusting member 172. The second portion 132 is positioned at another end of the blade 86. The second portion 132 has a left end of the first output shaft 82, that is, the left plate attaching part 206 inserted therethrough. A diameter of an opening of the second portion 132 is larger than a diameter of the left plate attaching part 206. The second portion 132 is not in contact with the left plate attaching part 206. The second portion 132 is disposed at a right end of the first output shaft 82. An attaching posture of the blade 86 relative to the second adjusting member 172 is adjusted by an attaching posture of the left attaching part 124 relative to the second adjusting member 172 being adjusted.

The working machine 2 further comprises a fastener 410. The fastener 410 is configured to attach the blade 86 to the first output shaft 82. The fastener 410 comprises a bolt 412, a washer 414, and a nut 416.

The bolt 412 comprises a shaft part 420 and a head part 422. The shaft part 420 extends in the left-right direction. The shaft part 420 penetrates the shaft through hole 400 of the first output shaft 82 in the left-right direction. Right and left ends of the shaft part 420 are disposed outside the first output shaft 82. The shaft part 420 has a substantially circular columnar shape. A diameter of the shaft part 420 is smaller than a diameter of the shaft through hole 400. The shaft part 420 is separated from the inner surface of the first output shaft 82 defining the shaft through hole 400. The shaft part 420 is not in contact with the first output shaft 82. The shaft part 420 comprises a thread groove 426. The thread groove 426 is defined at a left end of the shaft part 420 and in vicinity of the left end. The thread groove 426 is not screwed with the first output shaft 82. Due to this, the shaft part 420 is not attached to the first output shaft 82.

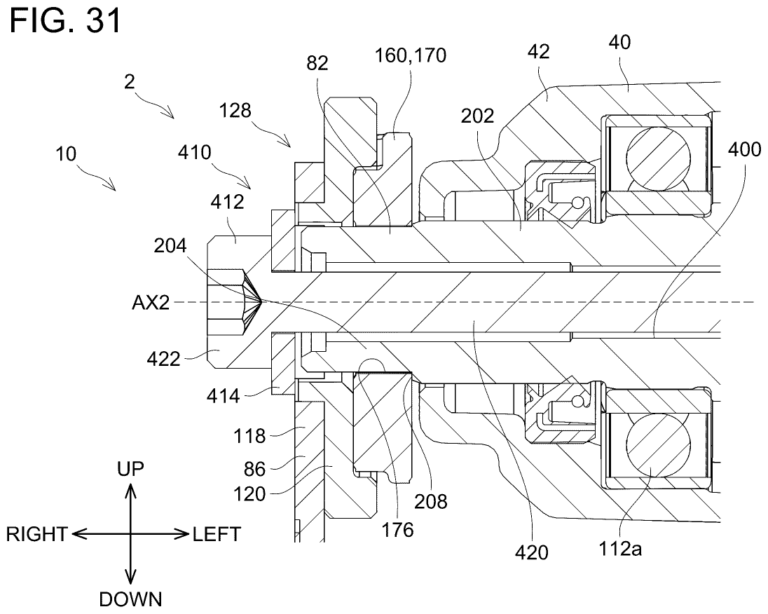

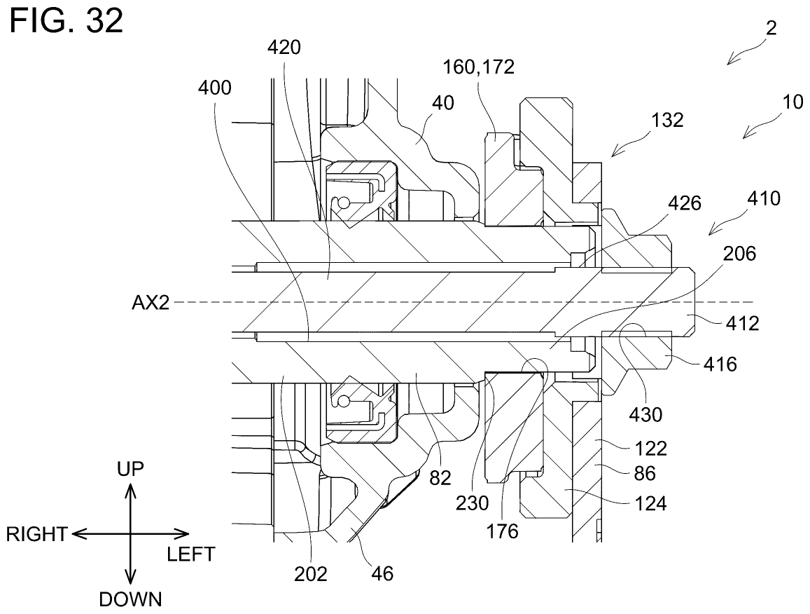

As shown in FIG. 31, the head part 422 is disposed at a right end of the shaft part 420. The head part 422 is disposed to the right of the first portion 128. The head part 422 contacts the first portion 128 via the washer 414 from the right. Because the right plate attaching part 204 does not penetrate the first portion 128, the head part 422 and the washer 414 are not in contact with the first output shaft 82. The first portion 128 is interposed between the head part 422 and the first adjusting member 170 via the washer 414. Due to this, with the bolt 412 screwed with the nut 416 (see FIG. 32), the first portion 128 can be suppressed from being detached from the first adjusting member 170.

As shown in FIG. 32, the nut 416 is disposed to the left of the second portion 132. The nut 416 is permanently attached to the second portion 132 for example by welding. A method of attaching the nut 416 to the second portion 132 may not be limited to welding. For example, the nut 416 may be permanently attached to the second portion 132 by the nut 416 and the blade 86 integrally formed.

The nut 416 has a thread groove 430. The nut 416 is screwed with the shaft part 420 via the thread groove 430 of the nut 416 and the thread groove 426 of the shaft part 420. The nut 416 contacts the second portion 132 from the left. Because the left plate attaching part 206 does not penetrate the second portion 132, the nut 416 is not in contact with the first output shaft 82. The second portion 132 is interposed between the nut 416 and the second adjusting member 172. Due to this, with the bolt 412 screwed with the nut 416, the second portion 132 can be suppressed from being detached from the second adjusting member 172.

In the present embodiment, when the motor 20 (see FIG. 2) operates, the first output shaft 82 swings. Due to this, the blade 86 swings along with the first adjusting member 170 and the second adjusting member 172. At this occasion, wobbling of the first adjusting member 170 relative to the first output shaft 82, wobbling of the first portion 128 relative to the first adjusting member 170, wobbling of the second adjusting member 172 relative to the first output shaft 82, and wobbling of the second portion 132 relative to the second adjusting member 172 may take place.

In a comparative example where the bolt 412 is screwed with the first output shaft 82, if the blade 86 abuts the ground with the blade 86 inclined relative to the ground while the above-mentioned wobbling is taking place, the head part 422 of the bolt 412 slides relative to the first portion 128. Due to this, the bolt 412 is loosened relative to the first output shaft 82. Contrary to this, in the present embodiment, the bolt 412 is not screwed with the first output shaft 82. For this reason, even if the blade 86 abuts the ground with the blade 86 inclined relative to the ground while the above-mentioned wobbling is taking place, the head part 422 can be suppressed from sliding relative to the first portion 128. Due to this, loosening of the fastener 410 can be suppressed.

### (Effects)

The working machine 2 according to the present embodiment comprises: the motor 20 (example for a prime mover); the first output shaft 82 (example for an output shaft) having a hollow shape and configured to move by movement of the motor 20; the blade 86 (example for a working member) comprising the first portion 128 disposed at the right end (example for one end) of the first output shaft 82 in the left-right direction (example for a longitudinal direction) of the first output shaft 82 and the second portion 132 disposed at the left end (example for another end) of the first output shaft 82 in the left-right direction, the blade 86 being configured to move by movement of the first output shaft 82, and the fastener 410 penetrating the first output shaft 82 in the left-right direction and configured to attach the blade 86 to the first output shaft 82 by interposing the first portion 128 and the second portion 132 between the fastener 410. The fastener 410 is not directly attached to the first output shaft 82.

In the configuration where the blade 86 is attached to the first output shaft 82 by the first and second portions 128 and 132 being interposed between the fastener 410 and the fastener 410 is directly attached to the first output shaft 82, the fastener 410 swings relative to the first and second portions 128 and 132 when load is applied to the blade 86. Due to this, the fastener 410 attached to the first output shaft 82 is loosened. According to the above configuration, while the blade 86 is attached to the first output shaft 82 by the first and second portions 128 and 132 being interposed between the fastener 410, whereas on the other hand, the fastener 410 is not directly attached to the first output shaft 82. Thus, even when load is applied to the blade 86, the blade 86 operates unitedly with the fastener 410. Due to this, the fastener 410 can be suppressed from being loosened.

The fastener 410 comprises: the bolt 412 comprising the head part 422 configured to contact the first portion 128 and the shaft part 420 configured to penetrate the first output shaft 82 in the left-right direction; and the nut 416 configured to contact the second portion 132 and be screwed with the shaft part 420.

According to the above configuration, with a simple configuration of the fastener 410, the fastener 410 can be suppressed from being loosened.

The nut 416 is permanently attached to the second portion 132.

According to the above configuration, even if load is applied to the blade 86, the blade 86 can easily operate unitedly with the fastener 410. Due to this, the fastener 410 can be further suppressed from being loosened.

The blade 86 is configured to swing about the central axis AX2 (example for a swing axis) by the movement of the first output shaft 82.

For example, in a configuration where the blade 86 rotates, when the blade 86 comes into contact with the ground for example, load in a rotating direction of the blade 86 is applied on the blade 86. Contrary to this, in the configuration where the blade 86 swings, when the blade 86 comes into contact with the ground, for example, load in a first swinging direction of the blade 86 and load in a second swinging direction opposite from the first swinging direction of the blade 86 are alternately applied on the blade 86. Due to this, in the configuration where the blade 86 swings, the fastener 410 can be more easily loosened than in the configuration where the blade 86 rotates. According to the above configuration, in a configuration where the fastener 410 can be easily loosened, the fastener 410 can be suppressed from being loosened.

The working machine 2 further comprises the first adjusting member 170 (example for a first intermediate member) attached to the first output shaft 82. The first portion 128 is attached to the first output shaft 82 via the first adjusting member 170.

In the above configuration, wobbling of the first adjusting member 170 relative to the first output shaft 82 and wobbling of the first portion 128 relative to the first adjusting member 170 may take place. In a configuration where the fastener 410 is directly attached to the first output shaft 82, when load is applied on the blade 86, the fastener 410 slides relative to the first portion 128 due to the wobbling of the first adjusting member 170 relative to the first output shaft 82 and the wobbling of the first portion 128 relative to the first adjusting member 170. Due to this, the fastener 410 can be easily loosened. Contrary to this, according to the above configuration, because the fastener 410 is not directly attached to the first output shaft 82, even when load is applied on the blade 86, the fastener 410 can be suppressed from sliding relative to the first portion 128 due to the wobbling of the first adjusting member 170 relative to the first output shaft 82 and the wobbling of the first portion 128 relative to the first adjusting member 170. Due to this, the fastener 410 can be suppressed from being loosened.

The first adjusting member 170 is configured to adjust the attaching posture of the blade 86 relative to the first adjusting member 170.

In the configuration where the first adjusting member 170 is configured to adjust the attaching posture of the blade 86 relative to the first adjusting member 170, wobbling of the first portion 128 relative to the first adjusting member 170 can easily take place. According to the above configuration, in the configuration where the wobbling of the first portion 128 relative to the first adjusting member 170 can easily take place, the fastener 410 can be suppressed from being loosened.

### (Modification)

The working machine 2 according to an aspect may be a working machine other than a weed remover, thus may be lawn clippers, reciprocating saws, a hedge trimmer, a ground trimmer, a broom, a brush, a sweeper, for example.

The working machine 2 according to an aspect may comprise a prime mover other than the motor 20, for example may comprise an engine.

The blade cover 300 according to an aspect may cover the blade part 116 by being attached to the front-end housing 40.

A cross-sectional shape of the blade cover 300 according to an aspect may not be substantially the same in the left-right direction.

In the working machine 2 according to the embodiment, the positioning part 180 of each of the adjusting members 160 comprises the three planar parts 190, 192, 194. In a modification, the number of planar parts may not be limited to three, but may be two, 4 or more and 12 or less.

In the working machine 2 according to an aspect, each of the adjusting members 160 may comprise protrusions, instead of the receiving grooves 198. In this case, the right attaching part 120 and the left attaching part 124 of the blade 86 may comprise receiving grooves instead of the protrusions 254, 274.

The fastener 410 according to an aspect may not comprise the washer 414. In this case, the head part 422 of the bolt 412 directly contacts the first portion 128.

In the fastener 410 according to an aspect, the nut 416 may be detachably attached to the second portion 132.

A method of fastening of the fastener 410 according to an aspect may not be limited to the screw method using the bolt 412 and the nut 416, but may be a fastening method using a shaft and a stopper/fastener that have a cam structure, and may be a fastening method by snap-fit.

The first adjusting member 170 according to an aspect may not be configured to adjust the attaching posture of the blade 86 relative to the first adjusting member 170. Also, the second adjusting member 172 may not be configured to adjust the attaching posture of the blade 86 relative to the second adjusting member 172. Due to this, the blade 86 is configured to be attached to the first adjusting member 170 and the second adjusting member 172 at one posture only.

The first output shaft 82 according to an aspect may be configured to rotate.

What is claimed is:

1. A working machine comprising:
a prime mover;
an output shaft configured to move by movement of the prime mover;
a first adjusting member detachably attached to the output shaft; and
a working member detachably attached to the first adjusting member,
wherein
the first adjusting member comprises:
an attaching part attached to the output shaft; and
an adjusting part attached to the working member and configured to adjust an attaching posture of the working member relative to the first adjusting member.

2. The working machine according to claim 1, wherein
the output shaft comprises a first shaft positioning part, and
the attaching part comprises a positioning part disposed at a specific position relative to the first shaft positioning part when the output shaft is attached to the attaching part.

3. The working machine according to claim 2, wherein
the output shaft is inserted into the attaching part,
the first shaft positioning part is disposed on an outer surface of the output shaft, and
the positioning part is disposed to face the first shaft positioning part when the output shaft is inserted into the attaching part.

4. The working machine according to claim 3, wherein
the first shaft positioning part comprises a first shaft planar part having a planar shape, and
the positioning part comprises a first planar part having a planar shape and configured to face and contact the first shaft planar part when the output shaft is inserted into the attaching part.

5. The working machine according to claim 4, wherein
the first shaft positioning part further comprises a second shaft planar part having a planar shape, and
the positioning part comprises a second planar part having a planar shape and configured to face and contact the second shaft planar part when the output shaft is inserted into the attaching part.

6. The working machine according to claim 1, wherein the working member is configured to swing about a swing axis by movement of the output shaft.

7. The working machine according to claim 6, wherein
the first adjusting member includes an outer peripheral surface having a circular shape with a center on the swing axis, and
the adjusting part is disposed at a portion of the outer peripheral surface of the first adjusting member along a circumferential direction of the first adjusting member.

8. The working machine according to claim 6, wherein in a first direction along which the swing axis extends, a width of the adjusting part is equal to or more than 30% and equal to or less than 70% of a width of the first adjusting member.

9. The working machine according to claim 6, wherein
one of the adjusting part and the working member comprises a plurality of receiving grooves aligned about the swing axis,
another of the adjusting part and the working member comprises a plurality of protrusions aligned about the swing axis,
each of the plurality of protrusions is configured to be received in a corresponding one the plurality of receiving grooves, and
a number of the plurality of protrusions is less than a number of the plurality of receiving grooves.

10. The working machine according to claim 6, wherein
the output shaft has a hollow shape,
the working member comprises:
a first portion disposed at one end of the output shaft in a longitudinal direction of the output shaft; and
a second portion disposed at another end of the output shaft in the longitudinal direction,
the working machine further comprises a fastener penetrating the output shaft in the longitudinal direction and configured to attach the working member to the output shaft by interposing the first portion and the second portion between the fastener, and
the fastener is not directly attached to the output shaft.

11. The working machine according to claim 10, wherein
the fastener comprises:
a bolt comprising a head part configured to contact the first portion and a shaft part configured to penetrate the output shaft in the longitudinal direction; and
a nut configured to contact the second portion and be screwed with the shaft part.

12. The working machine according to claim 11, wherein the nut is permanently attached to the second portion.

13. The working machine according to claim 5, wherein
the working member is configured to swing about a swing axis by movement of the output shaft,
the first adjusting member includes an outer peripheral surface having a circular shape with a center on the swing axis,
the adjusting part is disposed at a portion of the outer peripheral surface of the first adjusting member along a circumferential direction of the first adjusting member,
in a first direction along which the swing axis extends, a width of the adjusting part is equal to or more than 30% and equal to or less than 70% of a width of the first adjusting member,
one of the adjusting part and the working member comprises a plurality of receiving grooves aligned about the swing axis,
another of the adjusting part and the working member comprises a plurality of protrusions aligned about the swing axis,
each of the plurality of protrusions is configured to be received in corresponding one of the plurality of receiving grooves,
a number of the plurality of protrusions is less than a number of the plurality of receiving grooves,
the output shaft has a hollow shape,
the working member comprises:
a first portion disposed at one end of the output shaft in a longitudinal direction of the output shaft; and
a second portion disposed at another end of the output shaft in the longitudinal direction,
the working machine further comprises a fastener penetrating the output shaft in the longitudinal direction and configured to attach the working member to the output shaft by interposing the first portion and the second portion between the fastener,
the fastener is not directly attached to the output shaft,
the fastener comprises:
a bolt comprising a head part configured to contact the first portion and a shaft part configured to penetrate the output shaft in the longitudinal direction; and
a nut configured to contact the second portion and be screwed with the shaft part, and
the nut is permanently attached to the second portion.

14. A working machine comprising:
a prime mover;
an output shaft having a hollow shape and configured to move by movement of the prime mover;
a working member comprising a first portion disposed at one end of the output shaft in a longitudinal direction of the output shaft and a second portion disposed at another end of the output shaft in the longitudinal direction, the working member being configured to move by movement of the output shaft; and
a fastener penetrating the output shaft in the longitudinal direction and configured to attach the working member to the output shaft by interposing the first portion and the second portion between the fastener,
wherein
the fastener is not directly attached to the output shaft.

15. The working machine according to claim 14, wherein
the fastener comprises:
a bolt comprising a head part configured to contact the first portion and a shaft part configured to penetrate the output shaft in the longitudinal direction; and
a nut configured to contact the second portion and be screwed with the shaft part.

16. The working machine according to claim 15, wherein the nut is permanently attached to the second portion.

17. The working machine according to claim 14, wherein the working member is configured to swing about a swing axis by the movement of the output shaft.

18. The working machine according to claim 14, further comprising a first intermediate member attached to the output shaft,
wherein the first portion is attached to the output shaft via the first intermediate member.

19. The working machine according to claim 18, wherein the first intermediate member is configured to adjust an attaching posture of the working member relative to the first intermediate member.
